(19) United States
(12) Patent Application Publication
(10) Pub. No.: US 2026/0021529 A1
(43) Pub. Date: Jan. 22, 2026

(54) ACTOR-CRITIC LEARNING AGENT PROVIDING AUTONOMOUS OPERATION OF A TWIN ROLL CASTING MACHINE

(71) Applicant: NUCOR CORPORATION, CHARLOTTE, NC (US)

(72) Inventors: JIANQI RUAN, CHARLOTTE, NC (US); GEORGE T.C. CHIU, CHARLOTTE, NC (US); NEERA JAIN SUNDARAM, CHARLOTTE, NC (US); ROBERT GERARD NOONING, CHARLOTTE, NC (US); IVAN DAVID PARKES, CHARLOTTE, NC (US); WALTER N. BLEJDE, CHARLOTTE, NC (US)

(73) Assignee: NUCOR CORPORATION, CHARLOTTE, NC (US)

(21) Appl. No.: 18/994,950

(22) PCT Filed: Jul. 14, 2023
(86) PCT No.: PCT/US2023/027813

§ 371 Date: Jan. 15, 2025

Related U.S. Application Data
(60) Provisional application No. 63/389,697, filed on Jul. 15, 2022.
(60) Provisional application No. 63/448,911, filed on Feb. 28, 2023.

(51) Int. Cl. B22D 11/16; B22D 2/00; B22D 11/06; G06F 18/21; G06N 3/047; G06N 3/092

(52) U.S. Cl. CPC B22D 11/16; B22D 2/00; B22D 11/0622; G06F 18/2178; G06N 3/047; G06N 3/092

(57) ABSTRACT

A twin roll casting system comprises counter-rotating casting rolls having a nip between the casting rolls and capable of delivering cast strip downwardly from the nip, a casting roll controller configured to adjust at least one process control setpoint between the casting rolls in response to control signals, a cast strip sensor capable of measuring at least one parameter of the cast strip, and a controller coupled to the cast strip sensor to receive cast strip measurement signals from the cast strip sensor and coupled to the casting roll controller to provide control signals to the casting roll controller, the controller comprising a reinforcement learning (RL) Agent. The RL Agent further comprises a model-free actor-critic agent having a value function and a policy function, the RL Agent having been trained on a plurality of casting system operation datasets composed of casting runs executed by a plurality of different human operators.

### BACKGROUND

Twin-roll casting (TRC) is a near-net shape manufacturing process that is used to produce strips of steel and other metals. During the process, molten metal is poured onto the surface of two casting rolls that simultaneously cool and solidify the metal into a strip at close to its final thickness. This process is characterized by rapid thermo-mechanical dynamics that are difficult to control in order to achieve desired characteristics of the final product. This is true not only for steady-state casting, but even more so during “start-up”, the transient period of casting that precedes steady-state casting. Strip metal produced during start-up often contains an unacceptable amount of defects. For example, strip chatter is a phenomenon where the casting machine vibrates around 35 Hz and 65 Hz. More specifically, the vibration causes variation in the solidification process and results in surface defections, as shown in Figures 1A and 1B. Chatter needs to be brought below an upper boundary before commercially acceptable strip metals can be made.

During both the start-up and steady-state casting processes, human operators are tasked with manually adjusting certain process control setpoints. During the start-up process, the operators' goal is to stabilize the production of the steel strip, including reducing chatter, as quickly as possible so as to minimize the length of the start-up period subject to certain strip quality metrics being satisfied thus increasing product yield by minimizing process start up losses. They do this through a series of binary decisions (turning switches on/off) and the continuous adjustment of multiple setpoints. In total, operators control over twenty switches and setpoints; for the latter, operators must determine when, and by how much, to adjust the setpoint.

Among the setpoints that operators adjust. the casting roll separation force setpoint (to be referred to as the “force setpoint” from here onward) is the most frequently adjusted setpoint during the start-up process. It may be adjusted tens of times in an approximately five-minute period. Operators consider many factors when adjusting the force setpoint, but foremost is the strip chatter, a strip defect induced by the natural frequencies of the casting machine.

Operators use various policies for adjusting the force setpoint. One is to consider a threshold for the chatter measurement; when the chatter value increases above the threshold, operators will start to decrease the force. However, individual operators use different threshold values based on their own experience, as well as factors including the specific grade of steel or width being cast. On the other hand, decreasing the force too much can lead to other quality issues within the steel strip; therefore, operators are generally trained to maintain as high a force as possible subject to chatter mitigation.

Attempts have been made to improve various industrial processes, including twin roll casting. In recent years, human-in-the-loop control systems have become increasingly popular. Instead of considering the human as an exogenous signal. such as a disturbance, human-in-the-loop systems treat humans as a part of the control system. Human-in-the-loop applications may be categorized into three main categories: human control, human monitoring, and a hybrid of these two. Human control is when a human directly controls the process, this may also be referred to as direct control. Supervisory control is a hybrid approach in which human operators adjust specific setpoints and otherwise oversee a predominantly automatically controlled process. Supervisory control is commonly occurring in industry and has up to now, been the predominant regime for operating twin roll casting machines. However, variation between human operators, for example in their personality traits, past experiences, skill level, or even their current mood, as well as varying, uncharacteristic process factors, continue to cause inconsistencies in process operation.

Modeling human behavior as a black box problem has been considered. More specifically, researchers agree that system identification techniques can be useful for modeling human behavior in human-in-the-loop control systems. These generally reference predictive models of human behavior and subsequently, controller designs based on the identified models. The effectiveness of this approach of first identifying a model of the human's behavior and then designing a model-based controller is dependent upon the available data. Disadvantageously, if the human data contains multiple distinct operator behaviors, due to significant variations between different operators, any identified model will likely underfit the data and lead to a poorly performing controller.

Moreover, proposed approaches have been aimed at characterizing the human operator's role as a feedback controller in a system, but instead of modeling the human operator's behavior, they identify an optimal control policy based on the system model. In other words, they do not directly learn from the policy used by experienced human operators. In some industrial applications, especially during highly transient periods of operation such as process start-up, system modeling can be extremely difficult and not all control objectives can be quantified. Thus, automating such a process using model-based methods is not trivial; instead, a methodology is needed for determining the optimal operation policy according to both explicit control objectives and implicit control objectives revealed by human operator behavior.

### SUMMARY

A twin roll casting system comprises a pair of counter-rotating casting rolls having a nip between the casting rolls and capable of delivering cast strip downwardly from the nip, a casting roll controller configured to adjust at least one process control setpoint between the casting rolls in response to control signals, a cast strip sensor capable of measuring at least one parameter of the cast strip, and a controller coupled to the cast strip sensor to receive cast strip measurement signals from the cast strip sensor and coupled to the casting roll controller to provide control signals to the casting roll controller, the controller comprising a reinforcement learning (RL) Agent. The RL Agent further comprises a model-free actor-critic agent having a value function and a policy function, the RL Agent having been trained on a plurality of casting system operation datasets composed of casting runs executed by a plurality of different human operators.

In some embodiments, the RL Agent further comprises an advantage function which calculates an advantage value for a selected action as an immediate reward value for a selected action plus a discounted value of a subsequent state for the selected action minus a value of current state; and the advantage value is used to train the policy function. In some embodiments, the policy function is configured evaluate the advantage function in a way that values an action from the plurality of casting system operation datasets having a negative advantage value over actions that are not found in the plurality of casting system operation datasets.

In some embodiments, the RL Agent further comprises an advantage function which calculates an advantage value for a selected action as an immediate reward value for a selected action plus a discounted value of a subsequent state for the selected action minus a value of current state; and the natural exponent of the advantage value is used to train the policy function.

The cast strip sensor may comprise a thickness gauge that measures a thickness of the cast strip in intervals across a width of the cast strip. The process control setpoint may comprise a force setpoint between the casting rolls, and the parameter of the cast strip may comprise chatter.

In some embodiments, the RL Agent further comprises a reward function calculating an immediate reward as a weighted piecewise defined reward function based on user-defined thresholds for the chatter and edge spike parameters. In some embodiments, the RL Agent further comprises an advantage function which calculates an advantage value as the immediate reward value for a selected action plus a discounted value of a subsequent state for the selected action minus a value of current state.

The at least one parameter of the cast strip may comprise chatter and at least one strip profile parameter. The at least one strip profile parameter may be selected from the group consisting of edge bulge, edge ridge, maximum peak, and high edge flag.

The policy function may comprise a stochastic policy function. The policy function may further include a dependency on a previous step's action.

The data in an operational dataset may be augmented. In this embodiment, for each step in an operation dataset, recurrence from the previous step is embedded to improve the actor training process.

### BRIEF DESCRIPTION OF THE DRAWINGS

FIG. 1A is a strip profile without chatter defects.

FIG. 1B is a strip profile with chatter defects.

FIG. 2 is an illustration of a twin roll caster according to at least one aspect of the invention.

FIG. 3 is an illustration of details of the twin roll caster illustrated in FIG. 2.

FIG. 4 is a graph of mean force trajectory of clusters of training datasets.

FIG. 5A is a graph of examples of force trajectory of cluster 1 in FIG. 4.

FIG. 5B is a graph of examples of force trajectory of cluster 2 in FIG. 4.

FIG. 5C is a graph of examples of force trajectory of cluster 3 in FIG. 4.

FIG. 6A is a graph of maximum chatter amplitude spectrum of cluster 1 in FIG. 4.

FIG. 6B is a graph of maximum chatter amplitude spectrum of cluster 2 in FIG. 4.

FIG. 6C is a graph of maximum chatter amplitude spectrum of cluster 3 in FIG. 4.

FIG. 7 is a plot an RL Agent's force setpoint value trajectory and the associated chatter trajectory.

FIG. 8 is a plot comparing two RL Agent's force setpoint value trajectories and the associated chatter trajectory.

FIG. 9 is a second plot comparing two RL Agent's force setpoint value trajectories and the associated chatter trajectory.

FIG. 10 is a third plot comparing two RL Agent's force setpoint value trajectories and the associated chatter trajectory.

FIG. 11 is a fourth plot comparing two RL Agent's force setpoint value trajectories and the associated chatter trajectory.

FIG. 12 is a plot comparing an RL Agent's force setpoint value trajectories to an operator's force setpoint value trajectories and the associated chatter trajectory.

FIG. 13 is a second plot comparing an RL Agent's force setpoint value trajectories to an operator's force setpoint value trajectories and the associated chatter trajectory.

FIG. 14A is an illustration of thickness variation along a length of a cast strip.

FIG. 14B is an illustration of ripple defects in a cast strip profile, including edge spike.

FIG. 15 is a schematic of a cast strip cross section describing edge spike parameters.

FIG. 16 is a graph of average silhouette width versus number of clusters for operational data sets.

FIG. 17 shows silhouette width of each sample under different clustering settings.

FIG. 18A illustrates an example of force trajectories in a first cluster.

FIG. 18B illustrates an example of force trajectories in a second cluster.

FIG. 19A illustrates RL Agent verification under a first case of initial edge spikes.

FIG. 19B illustrates RL Agent verification under a second case of initial edge spikes, the second case having lower edge spoke than the first case.

FIG. 20A illustrates RL Agent verification under a third case of initial edge spikes.

FIG. 20B illustrates RL Agent verification under a fourth case of initial edge spikes, the fourth case having similar edge spikes to the third case.

FIG. 21 is a simplified drawing of a twin roll caster showing the relationship of Roll Separation Force to cast steel strip.

FIG. 22 illustrates trajectories of force and control objectives of human operator and RL Agent without augmented dataset control under a fifth case of operating conditions.

FIG. 23 illustrates trajectories of force and thickness with corresponding losses of human operator and RL Agent without augmented dataset control under the fifth case of operating conditions.

FIG. 24 illustrates trajectories of force and control objectives of human operator and RL Agent with augmented dataset control under a fifth case of operating conditions.

FIG. 25 illustrates trajectories of force and thickness with corresponding losses of human operator and RL Agent with augmented dataset control under the fifth case of operating conditions.

### DETAILED DESCRIPTION

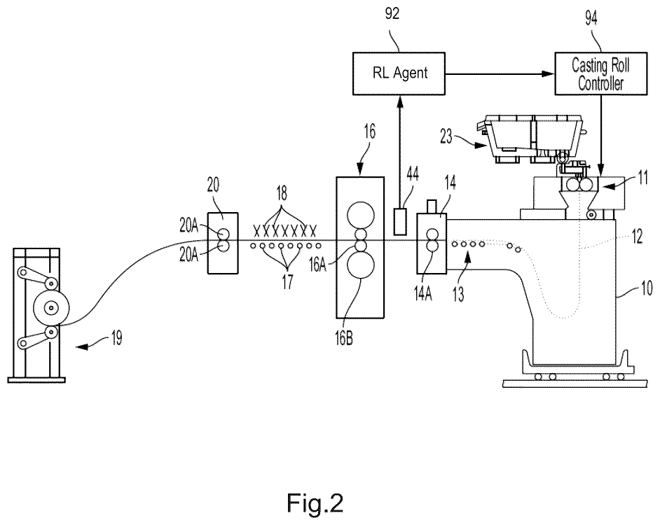

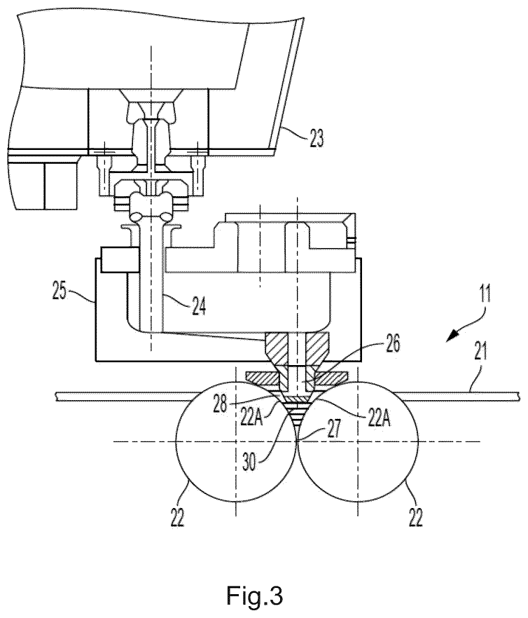

Referring to FIGS. 2 And 3, a twin-roll caster is denoted generally by 11 which produces thin cast steel strip 12 which passes into a transient path across a guide table 13 to a pinch roll stand 14. After exiting the pinch roll stand 14, thin cast strip 12 passes into and through hot rolling mill 16 comprised of back op rolls 16B and upper and lower work rolls 16A where the thickness of the strip reduced. The strip 12, upon exiting the rolling mill 15, passes onto a run out table 17 where it may be forced cooled by water (or water/air) jets 18, and then through pinch roll stand 20 comprising a pair of pinch rolls 20A and to a coiler 19.

Twin-roll caster 11 comprises a main machine frame 21 which supports a pair of laterally positioned casting rolls 22 having casting surfaces 22A and forming a nip 27 between them. Molten metal is supplied during a casting campaign from a ladle (not shown) to a tundish 23, through a refractory shroud 24 to a removable tundish 25 (also called distributor vessel or transition piece), and then through a metal delivery nozzle 26 (also called a core nozzle) between the casting rolls 22 above the nip 27. Molten steel is introduced into removable tundish 25 from tundish 23 via an outlet of shroud 24. The tundish 23 is fitted with a slide gate valve (not shown) to selectively open and close the outlet 24 and effectively control the flow of molten metal from the tundish 23 to the caster. The molten metal flows from removable tundish 25 through an outlet and optionally to and through the core nozzle 26.

Molten metal thus delivered to the casting rolls 22 forms a casting pool 30 above nip 27 supported by casting roll surfaces 22A. This casting pool is confined at the ends of the rolls by a pair of side dams or plates 28, which are applied to the ends of the rolls by a pair of thrusters (not shown) comprising hydraulic cylinder units connected to the side dams. The upper surface of the casting pool 30 (generally referred to as the “meniscus” level) may rise above the lower end of the delivery nozzle 26 so that the lower end of the deliver nozzle 26 is immersed within the casting pool.

Casting rolls 22 are internally water cooled by coolant supply (not shown) and driven in counter rotational direction by drives (not shown) so that shells solidify on the moving casting roll surfaces and are brought together at the nip 27 to produce the thin cast strip 12, which is delivered downwardly from the nip between the casting rolls.

Below the twin roll caster 11, the cast steel strip 12 passes within a sealed enclosure 10 to the guide table 13, which guides the strip through an X-ray gauge used to measure strip profile to a pinch roll stand 14 through which it exits sealed enclosure 10. The seal of the enclosure 10 may not be complete, but is appropriate to allow control of the atmosphere within the enclosure and access of oxygen to the cast strip within the enclosure. After exiting the sealed enclosure 10, the strip may pass through further sealed enclosures (not shown) after the pinch roll stand 14.

A casting roll controller 94 is coupled to actuators that control all casting roll operation functions. One of the controls is the force set point adjustment. This determines how much force is applied to the strip as it is being cast and solidified between the casting rolls. Oscillations in feedback from the force actuators is indicative of chatter. Force actuator feedback may be provided to the casting roll controller or logged by separate equipment/software.

A controller 92 comprising a trained RL Agent which is coupled to the casting roll controller 94 by, for example, a computer network. The controller 92 provides force actuator control inputs to the casting roll controller 94 and receives force actuator feedback. The force actuator feedback may be from commercially-available data logging software or the casting roll controller 94.

In some embodiments, before the strip enters the hot roll stand, the transverse thickness profile is obtained by thickness gauge 44 and communicated to Controller 92.

The present invention avoids disadvantages of known control systems by employing a model-free reinforcement learning engine, such as a deep Q network (DQN) that has been trained on metrics from manually controlled process including operator actions and casting machine responses as the RL Agent in controller 92. A DON is a neural network that approximates the action value of each state-action pair.

In a first embodiment provided below, the configuration and training of an RL Agent having one action and a reward function having one casting machine quality metric is provided. However, this is for clarity of the disclosure and additional actions and casting machine feedback responses may be incorporated in the RL Agent. Additional actions include rolling mill controls. Additional metrics may include cast strip profile measurements and flatness measurements, for example. Also, while the various embodiments disclosed herein use a RL Agent as an example, other model-free adaptive and/or learning agents may also be suitable and may be substituted therefore in any of the disclosed embodiments.

In a first embodiment, the DON is a function mapping the state to the action values of all actions in the action set, as shown in Equation 1, where Q is the neural network, S is the state information of a sample, and {qₐ_{₁}, qₐ_{₂}, . . . qₐ_{_{N}}} corresponds to action values of N elements in the action set.

$$Q : ( S ) \to [ {q}_{{a}_{1}} , {q}_{{a}_{2}} , ... {q}_{{a}_{N}} ] \qquad ( 1 )$$

In some embodiments, the state at time step t is defined as Sₜ=[CₜδCₜ, Fₜ, δFₜ] where C and δC are the chatter and change in chatter over one time step, respectively, and F and δF are the force and change in force over one time step, respectively. In some embodiments, the casting data is recorded at 10 Hz. The force setpoint adjustment made by operators may be downsampled to 0.2 Hz based on the observation that operators generally do not adjust the force setpoint more frequently than this. Given the noise characteristics of the chatter signal, every 50 consecutive samples may be averaged (i.e. average chatter over a 5 second period) to obtain C. In some embodiments, non-overlapping 5 second blocks are used. Two index subscripts to represent a data sample, namely t and k. The time index t denotes the time step within a single cast sequence. The sample index k denotes the unique index of a sample in the dataset, which contains samples from all cast sequences.

In some embodiments, the action is defined as the change in the force setpoint value between the current time step and the next time step. Unlike the state, which is continuous-valued, the action is chosen from a discrete set A ∈αᵢ, {i=1,2, . . . , N}. In the problem considered here, N =4; there are three frequently used force reduction rates and the last action stands for keeping the force value unchanged.

In reinforcement learning (RL), the reward reflects what the user values and what the user avoids. In the context of using RL to design a policy for adjusting a process setpoint, there are two types of information that can be used: 1) the behavior of “expert” operators and 2) performance metrics defined explicitly in terms of the states. Each play a distinct role in defining a reward function that incentivizes the desired behavior.

Given that human operators may control this process as based on general rules of thumb and their individual experience with the process, a reward function that aims to emulate the behavior of operators is a way to capture their expertise without needing a model of their decision-making. On the other hand, if the reward function were to be designed to only emulate their behavior, then the trained RL Agent will not necessarily be able to improve upon the operators' actions. To do the latter, it is useful to consider a second component of the reward function that places value on explicit performance metrics. For example, in the force setpoint adjustment problem addressed in this first embodiment, the desired performance objectives are a short start-up time, below some upper bound Tₛᵤ, and a low chatter level, below some upper bound C_{ub}, discussed below.

In some embodiments, implicit characterization of performance objectives include the following. To better characterize different force setpoint adjustment behaviors, a k-means clustering algorithm may be applied to cluster over 200 individual cast sequences, based on the force setpoint trajectory implemented by operators during each cast for a given metal grade and strip width, all of the cast sequences represent the same metal grade and strip width to ensure that differences identified through clustering are a function of the behaviors of the human operator working during each casting campaign for that grade and width.

Additional grades and widths may be characterized in a similar fashion. Alternatively. additional grades and widths can use the same trained RL Agent, but with different starting points assigned to the different grades and widths.

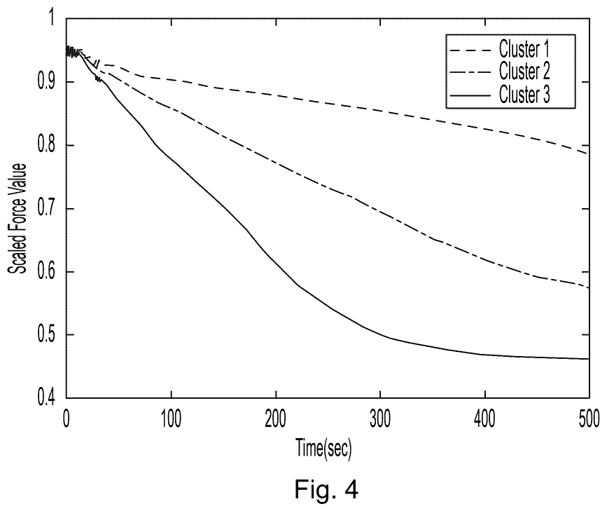

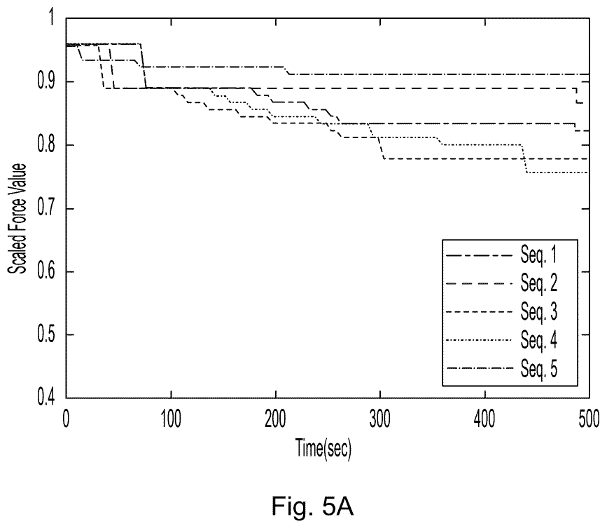

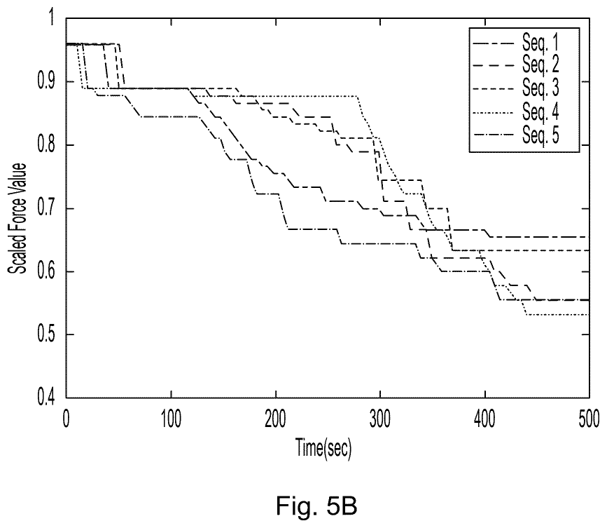

In the example herein, the force setpoint adjustment behavior is characterized by a 500-second period force setpoint trajectory after an initial, automatic adjustment. In one example, among the available cast data sequences, a total of 6 different operators' behavior is represented. During a given cast, the process is operated by a crew of 2 operators, with one responsible for the force setpoint adjustments. To account for distinct force setpoint adjustment behaviors by different crews, training data sets are cluster and preferred behaviors identified. In some embodiments, k={3, 4, 5, 6} for the k-means algorithm. The clustering result is the most stable for k=3 for the data set in this example. Only 2% of the cast sequences keep shifting from one cluster to another. Other values of k may be appropriate for other data sets. FIG. 4 shows the mean force trajectories, computed by averaging each time step's value in the force trajectories of each cluster, separately. FIGS. 5(a)-5(c) show examples from each of the three clusters. FIGS. 6(a)-6(c) show histograms of chatter amplitude for each of three clusters. According to Table I, Cluster 3 has the shortest mean start-up time but not the smallest start-up time variation; Cluster 1 has the smallest start-up time variation but not the shortest mean start-up time.

Cluster 3 is also characterized by the most aggressive setpoint adjustment behavior, both in terms in the rate at which the force setpoint is decreased as well as the total magnitude by which it is decreased. Another feature of the cast sequences belonging to Cluster 3 is that they cover a wider range of force setpoint values due to the aggressive adjustment of the setpoint. Cluster 3 is preferred because it has the shortest average start-up time and the lowest overall chatter level among three force behavior clusters.

TABLE I
Scaled time performance statistics of force clusters; mean start-up
time and standard deviation are normalized to Cluster 2.

| | | | |
|---|---|---|---|
| Percentage in the dataset (%) | 25.7 | 34.7 | 39.6 |
| Scaled start-up time mean | 0.99 | 1.00 | 0.94 |
| Scaled start-up time standard deviation | 0.78 | 1.00 | 1.21 |

In addition to rewarding emulation of certain operator setpoint adjustment behaviors. the reward function should explicitly incentivize desired performance metrics, With respect to achieving a short start up time, Tₛᵤ, it is important to equally reward or penalize each time step, because it is not known whether decisions made near the start of the cast do or do not lead to a short start-up time. To emphasize that cast sequences with different start-up times should be rewarded differently, in some embodiments, the time reward for each step is

$$[ - exp ( \frac{Tsu - Tub}{Tub} ) ]$$

where Tₛᵤ is start-up time and T_{ub} is the upper bound on the start-up time as deemed acceptable by the user. The exponential function leads to an increasing penalty rate as the sequence start-up time Tₛᵤ approaches the upper bound.

In this embodiment, the second performance objective is to maintain a chatter value below some user-defined threshold. Therefore, a maximum acceptable chatter value, denoted by C_{ub} is defined; if the chatter value is lower than C_{ub}, there is no chatter penalty assigned to that step. Mathematically, the chatter reward can be expressed as [min(0, C_{ub}-Cₜ)]. Decreasing the force too much, at the expense of decreasing chatter, can lead to other quality issues with the steel strip. Therefore, a lower bound on the acceptable force, F_{lb} is also enforced.

The total reward function is shown in Equation 2:

$${R}_{t} = 1 + min ( 0 , {C}_{ub} - {C}_{t} ) - exp ( \frac{Tsu - Tub}{Tub} ) + 1 ( if in preferred cluster ) \qquad ( 2 )$$

In addition to the implicit and explicit performance objectives described above, a constant reward is applied at each sample using the first term of Rₜ. According to the casting campaign records, it may be observed that the operators often refrain from decreasing the force setpoint at a given time step when both the chatter value and start-up time are within acceptable levels at a given sample. To incentivize the RL Agent to learn from this behavior, a constant reward is assigned to each sample obtained from operators' cast records. If, for a sample, the sum of both time and chatter penalties (negative rewards) is less than the constant, and the net reward of this sample is still positive. Furthermore, to emphasize that there is a specific type of behavior that is desirable for the RL Agent to learn from, an extra constant may be assigned reward to samples in a cast sequence from the preferred cluster of force behavior, and the net reward of each of these samples will be positive. Associated with a modified training algorithm below, these positive net rewards motivate the RL Agent to follow the operator's behavior under certain situations.

In a typical DQN training process, the RL Agent executes additional trials based on the updated value function and collects more data from new trials. However, the expense of operating an actual twin roll strip steel casting machine, including materials considered and produced renders training the RL Agent to execute trials on an actual casting machine infeasible. In this case, all available samples from operator controlled casting campaigns are collected from the cast to train the value function Q in each training step. Training may be continued on an actual operating casting machine.

In some embodiments, the DON is initialized and trained using a MATLAB deep learning toolbox. However, other reinforcement learning networks and tools may be used. Specifically, as shown in Algorithm 1. the train( ) function is employed, and states S_{K} of all samples as network inputs and their corresponding action values q_{K} are used as labels to train the parameter set Φ of the value function.

Algorithm 1 Pseudocode of deep Q-network learning process (modified version)

| | |
|---|---|
| 1: | Initialize discount factor y |
| 2: | Initialize the parameter set φ, and create a neural network Q [symbol] |
| 3: | Initialize action values q [symbol] of every sample |
| 4: | Train Q [symbol] with all samples: Q [symbol] ← train(Q [symbol] , S_{K}, q_{K}) |
| 5: | for each iteration do |
| 6: | Update q [symbol] qk = onehot(Aₖ) * Rₖ + (1 − d)γ(max(Qφ(Sₖ [symbol] ))) * ones(1, N ) |
| 7: | Train Q [symbol] with all samples: Q [symbol] ← train(Q [symbol] , S_{K}, q_{K}) |
| 8: | end for as every q [symbol] converges |

[symbol]

indicates data missing or illegible when filed

Another modification in the training process is the update of the action values qₖ. qₖ is a 1-by-N vector, and each entry of it represents the action value of one action option. As shown in the following equation 3;

$$qk = onehot ( {A}_{k} ) * {R}_{k} + ( 1 - d ) γ ( max ( {Q}_{φ} ( {S}_{{k}^{′}} ) ) ) * ones ( 1 , N ) \qquad ( 3 )$$

where onehot(Aₖ) is the one-hot encoding of the action Aₖ, (a 1-by-N vector with the entry of the selected action being one and the rest being zeros), d is a binary indicator to indicate if the current, state is the terminal of a trajectory, ones is a 1-by-N vector with all entries being ones, and Sₖ, is the state one time step after the current state Sₖ. This equation updates the action value of the selected action as the sum of the immediate reward and a discounted maximum value of the state at the next time step. However, for those actions not being selected, instead of approximating their action values by using the value function from the previous iteration, their action values are set as zero plus the discounted maximum value of the next state. This qₖupdate works more like a labeling process of a classification problem. If the immediate reward is positive, the trained RL Agent is more likely to act as the operator does, and increasing the immediate reward raises the likelihood of emulating the operator's behavior. Conversely, if the immediate reward is negative, the action selected by the operator is less likely to be selected than the other N-1 actions not being selected. In addition, the likelihood of selecting each of the N-1 actions increases equally.

By combining the DQN with a greedy policy and selecting the most valuable action under each given state, the trained RL Agent can adjust the force setpoint. The RL Agent is asked to provide force setpoint adjustments based on available cast sequence data and record the force setpoint trajectory for each cast sequence in the validation set. A more specific testing process is shown in Algorithm 2.

Algorithm 2 Pseudocode of the agent examination

| | |
|---|---|
| 1: | Obtain F₁, C₁ C₀ from cast sequence data |
| 2: | Initialize δ(F₁) = 0 |
| 3: | Calculate δ(C₁) = C₁ − C₀ |
| 4: | Form the first state: S₁ = [F₁, δ(F₁), C₁, δ(C₁)] |
| 5: | Import the trained action-value function Q |
| 6: | Initialize time step t = 1 |
| 7: | for each time step t do |
| 8: | Calculate the action values at the current state: |
| | $[ {q}_{{a}_{1}}^{t} , {q}_{{a}_{2}}^{t} , ... , {q}_{{a}_{N}}^{t} ] ← Q ( {S}_{t} )$ |
| 9: | $Select action based on the action values : {A}_{t} ← arg {max}_{{a}_{i}} ( {q}_{{a}_{i}}^{t} )$ |
| 10: | Obtain Cₜ₊₁ from the cast sequence. |
| 11: | Calculate δ(Cₜ₊₁) ← Cₜ₊₁ − Cₜ |
| 12 | if Fₜ > F_{lb} then |
| 13: | Update δ(Fₜ₊₁) ← Aₜ |
| 14: | Calculate Fₜ₊₁ ← Fₜ + Aₜ |
| 15: | else |
| 16: | Update δ(Fₜ₊₁) ← 0 |
| 17: | Calculate Fₜ₊₁ ← Fₜ |
| 18: | end if |
| 19: | Form the next state: Sₜ₊₁ ← [Fₜ₊₁, δ(Fₜ₊₁), Cₜ₊₁, δ(Cₜ₊₁)] |
| 20: | Update t ← t + 1 |
| 21: | end for Until cast sequence ends |

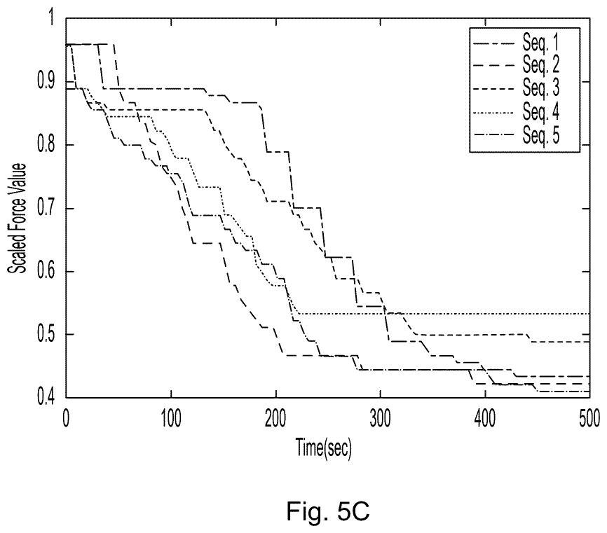

Algorithm 2 is used to calculate and collect each RL Agent's force decision-making trajectories under different chatter scenarios. FIG. 7 contains the RI. Agent's force setpoint value trajectory and the associated chatter trajectory under which these force adjustments are made for T_{ub}=500, C_{ub}=0.5, and with a preference for operator behavior described by Cluster 3. The RL Agent begins to reduce the force setpoint as the chatter exceeds the specified threshold and/or the chatter has an increasing trend; similarly, the RI Agent halts further reduction of the force setpoint as the chatter decreases below the threshold and/or the chatter shows a decreasing trend. As expected, these results are consistent with the design of the reward function.

To demonstrate the sensitivity of the trained RL Agent to the operator data used for training, two different preferred clusters are created. The first contains only cast sequences from the most aggressive cluster (Cluster 3 from the k-means clustering results) while the second contains cast sequences from both the most aggressive cluster (Cluster 3) and the moderate cluster (Cluster 2). Both RL Agents are trained with the same dataset but different preferred cluster settings. Cast sequences belonging to Cluster 3 are considered as preference in both training settings because these data include system operation across the full range of possible force state values, whereas data belonging to Clusters 1 and 2 did not.

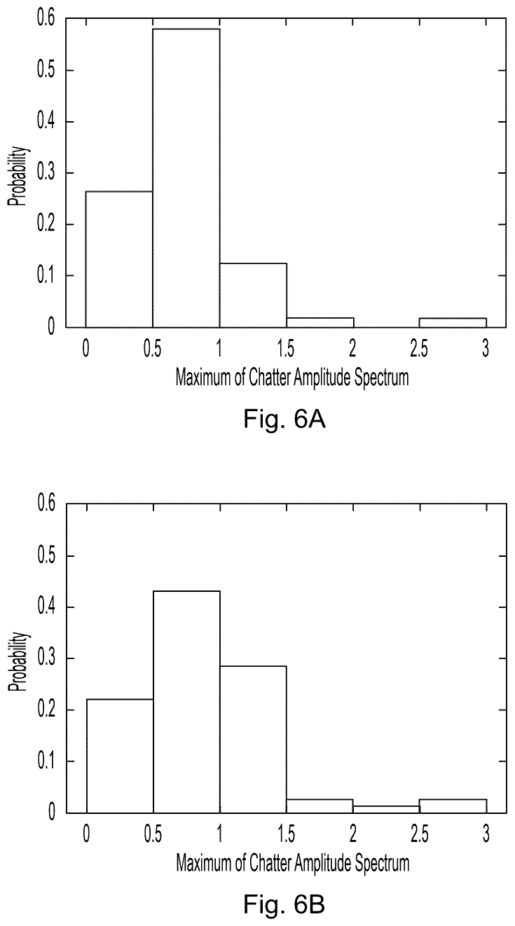

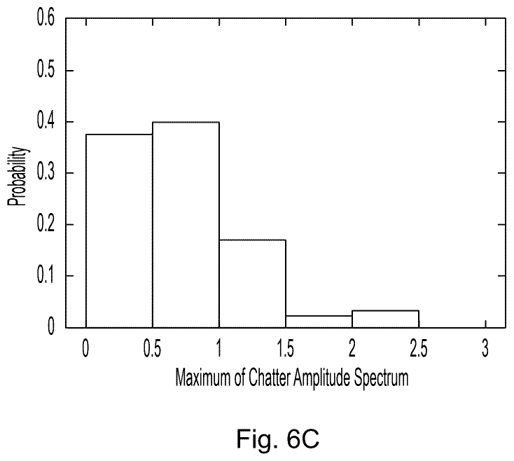

FIGS. 8 and 9 give examples of RL Agent reactions under different chatter scenarios, RL Agent A, the one trained with the reward function preferring the most aggressive operator behavior, chooses to decrease the force setpoint more rapidly than RL Agent B, which was trained with the reward function preferring both moderate and aggressive operator behavior. These results are consistent with the design of the reward function and demonstrate how the choice of operator behavior used for training influences each RL Agent.

To demonstrate the sensitivity of the reward function to changes in the performance specifications, other parameters in the reward function may be fixed but vary the maximum acceptable chatter value, C_{ub} and train two RL Agents. Table II shows details of the reward function settings of two RL Agents.

TABLE II
Agents C and D parameter settings

| | Chatter value | Start-up time | Preferred |
|---|---|---|---|
| Agent | threshold C_{ub} | threshold T_{ub} | Cluster |
| C | 0.5 | 500 | 3 |
| D | 1 | 500 | 3 |

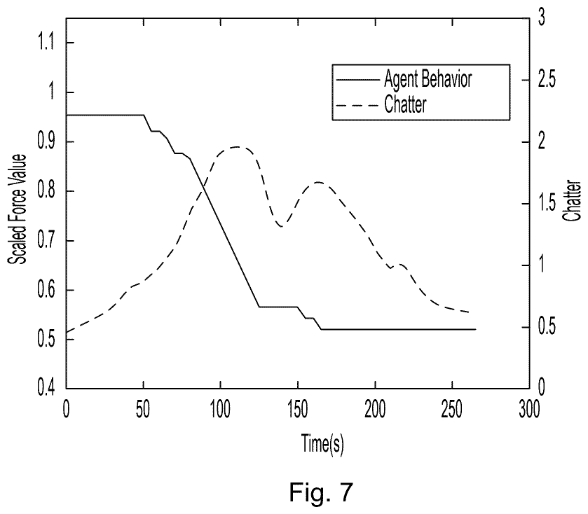

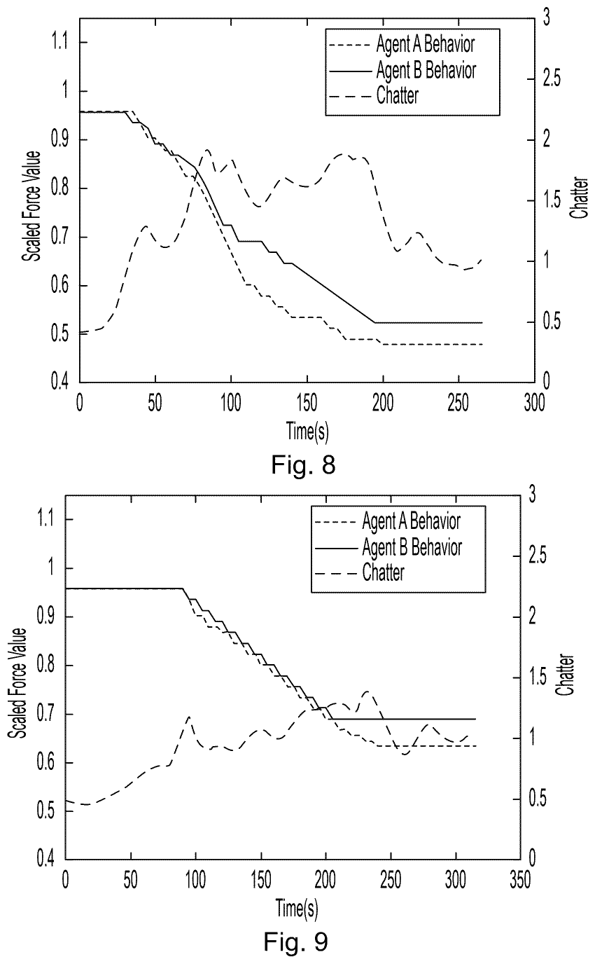

FIGS. 10 and 11 provide examples of RL Agent reactions under different chatter scenarios. RL Agent C, trained with a lower maximum acceptable chatter value. displays a more aggressive force adjustment behavior than RL Agent D, the one trained with a higher maximum acceptable chatter value. This is again consistent with the design of the reward function and demonstrates how the performance specifications affect each RL Agent's behavior even when the same data is used to train each RL Agent.

Ultimately, the purpose of training an RL Agent to automatically adjust the force setpoint, is to improve the performance and consistency of the twin-roll strip casting process (or other process as may be applicable). To validate the trained RL Agent before implementing the RL Agent on an operating twin-roll caster, the trained RL Agent's behavior is directly compared to that of different human operators. Because the RL Agent is not implemented on an online casting machine for validation purposes, the comparison is between the past actions of the operator (in which their decisions impacted the force state and in turn, the chatter) to what the RL Agent would do given those particular force and chatter measurements. Nonetheless, this provides some basis for assessing the differences between human operator and machine RL Agent.

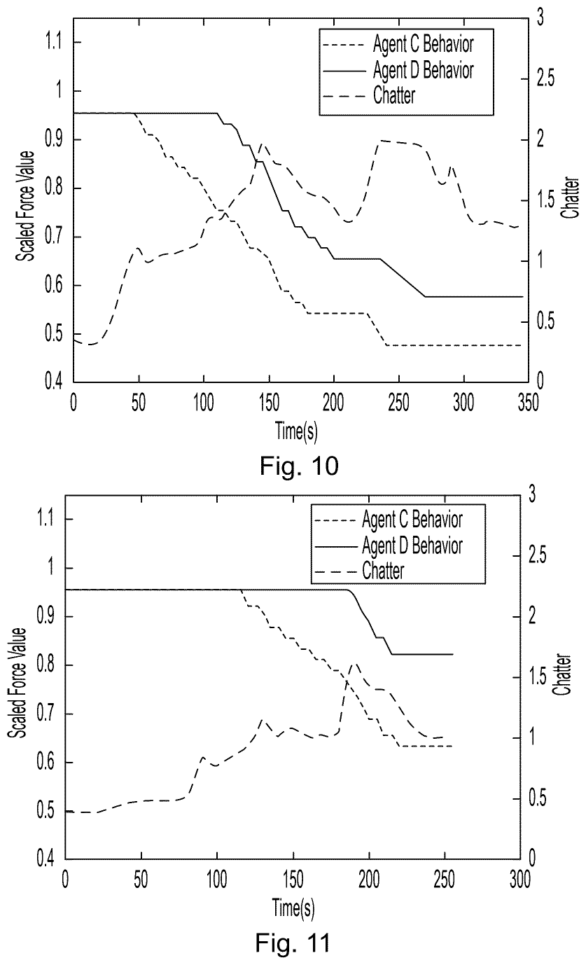

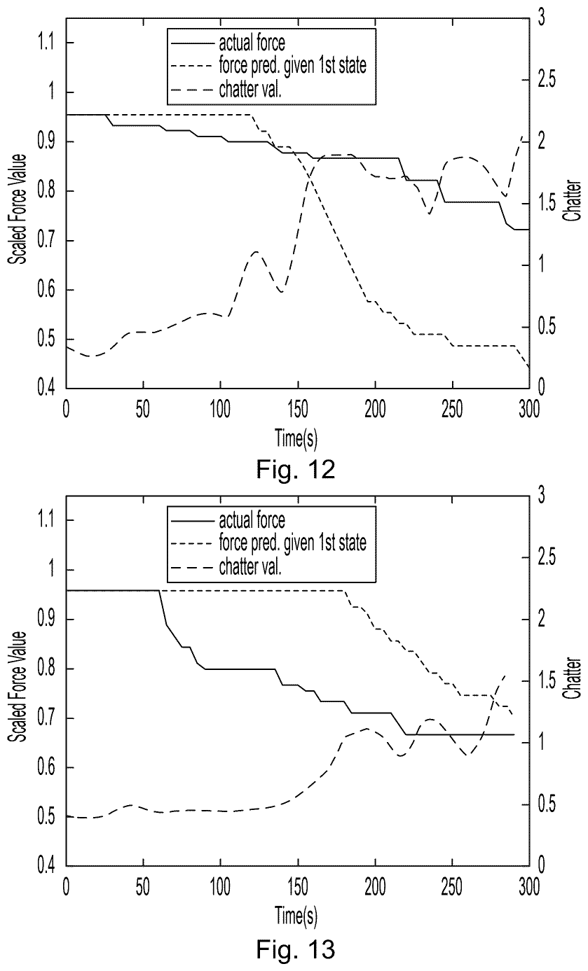

In one example, RL Agent C is compared with a human operator behavior in two different casts. In FIG. 12, the operator does not reduce the force setpoint even though the chatter shows a strong increasing trend. In FIG. 13, the operator starts to reduce the force before the chatter begins to increase. Engineers with expertise in twin-roll strip casting evaluated these comparisons and deemed the RL Agent's behavior to be preferable over that of the human operator. However, it is important to note that in each case, the human operator may be considering other factors, beyond chatter, affecting the quality of the strip that may explain their decision-making during these casts.

In some embodiments, additional casting machine responses are added to the reward function. For example, in some embodiments, strip profile is measured by gauge 44 and provided to the RL Agent 92. Gauge 44 may be located between the casting rollers and the hot rolling mill 16. Strip profile parameters may include edge bulge, edge ridge, maximum peak versus 100 mm, and high edge flag. Each of these may be assigned an upper boundary. As with the chatter reward function, reward functions for profile parameters are designed to assign negative reward as the measured parameters approach their respective upper bound. These reward functions may be scaled, for example, to assign equal weight to each parameter, and then summed. The sum may be scaled to ensure the chatter reward term is dominant, at least during start up. An example of such a reward function is shown in equation 4:

$${R}_{obj} = min ( 0 , {C}_{ub} - C ) + \frac{1}{4} ( {\sum }_{i ∈ \{ bg \cdot rg \cdot mp \cdot fg \}} min \frac{( 0 , {i}_{ub} - i )}{{λ}_{i}} ) - exp ( \frac{{T}_{st} - {T}_{ub}}{{T}_{ub}} ) \qquad ( 4 )$$

where C is chatter, bg is edge bulge, rg is edge ridge, mp is max peak versus 100 mm, and fg is high edge flag. This results in the reward function having a chatter score and a profile score. Additional profile parameters that may be measured and included in a reward function include overall thickness profile, profile crown, and repetitive periodic disturbances related to the rotational frequency of the casting rolls.

In another embodiment, each of the embodiments described above can be extended to operating the casting machine in a steady state condition, after the start-up time as passed. In some embodiments, the reward function is modified, for example, to eliminate the start-up time term. For example, in the embodiment having both chatter and profile terms provided above, the reward function may be modified as shown in equation 5:

$${R}_{obj} = min ( 0 , {C}_{ub} - C ) + \frac{1}{4} ( {\sum }_{i ∈ \{ bg , rg , mp \cdot fg \}} min \frac{( 0 , {i}_{ub} - i )}{{λ}_{i}} ) \qquad ( 5 )$$

The relative weights of the chatter and profile reward functions may also be adjusted.

In other embodiments, a different reward function is developed for steady state operation and a different RL Agent is trained for steady state operations. In other embodiments, a model-based A.I. agent is developed and trained for steady state operation. In some embodiments, one or more model based controllers are operated concurrently with a trained model-free RL Agent. For example, an Iterative Learning Controller may control wedge to reduce periodic disturbances as in WO 2019/060717A1, which is incorporated by reference, and any of the RL Agents described herein may effectuate the actions to reduce chatter and/or profile defects.

In the Deep Q Network RL Agent above, it is shown that the trained RL Agent can independently adjust one setpoint based on a single objective signal. However, it may be desirable to extend the RL Agent to multiple objective signals and a reward function containing multiple time-varying objectives, to determine and apply an offset can be unpractical. In addition, since the training process only uses a finite dataset from human records, an imbalanced dataset can also impact the agent's behavior negatively.

Accordingly, in another embodiment of a RL Agent, a modified actor-critic algorithm is provided to a control problem in which multiple control objectives are defined. Similar to the modified DON algorithm above, the modified actor-critic algorithm trains the RL Agent with only the human records. The trained agent is also expected to take the most rewardable action done by some operators under a similar situation. However, instead of applying an offset to the reward function, an actor-critic algorithm is employed which trains the policy function as a multiple-class classification problem, so that cost-sensitive methods can be applied to update the policy function based on both the reward and the action distribution in the dataset. In addition, this method is applied to learn a setpoint control strategy in a twin-roll casting process and show that the trained agent can independently make reasonable and consistent setpoint adjustments under the given scenario.

The nomenclature provided in Table III below is followed for the discussion of the Actor-Critic algorithms.

TABLE III
Nomenclature

| Symbol | Description |
|---|---|
| S | State |
| A | Action |
| Δ(.) | Difference in (.) between two consecutive steps |
| D | Training database |
| F | Roll separation force setpoint value |
| R | Immediate reward |
| N | Number of samples in the training database |
| Φ | Parameter set of the value function |
| Ψ | Parameter set of the policy function |
| Sub/superscript Description | |
| (.)ₖ | Discrete time index |
| (.)ᵢ | Sample index in a database |
| (.)_{lb} | Lower bound of (.) |

The RL Agent using an actor-critic algorithm includes two main functions, a value function and a policy function. The value (critic) function V maps a state to its value, which is defined as the expected long term reward starting from the given state; that is

$$V : {S}_{k} \to 𝔼 ( {\sum }_{t = k}^{∞} {γ}^{t - k} {R}_{t} \vert {S}_{k} ) .$$

The policy (actor) function π maps a state-action pair to a probability value between 0 and 1, which represents, under this policy, how likely the action A is to be taken at the given state S. The RL Agent interacts with the real or simulated environment according to the policy function π and collects the current state S, the action A, the state at the next time step S+1, and the immediate reward R to update both the value and the policy function. Immediate reward R may be calculated as shown in equations 2, 4, or 5 above, the piecewise defined reward function of equation 9 below, or other suitable reward function. Considering a finite training dataset, the value function can be evaluated as shown in Algorithm 3.

Algorithm 3 Pseudocode of the value (critic) function training process

| | |
|---|---|
| 1: | Initialize |
| 2: | Form the training dataset with samples: d [symbol] ∈ D, d [symbol] = {Sₖ [symbol] , Aₖ [symbol] , S₍ₖ₊₁₎ [symbol] , Rₖ [symbol] }, [symbol] = |
| | 1,2, ... N, |
| 3: | Φ₀ = argmin Σ_{d} [symbol] _{∈D}\|V(Sₖᵢ\|Φ) − Rₖᵢ\|₂ |
| 4: | for f = 1: iteration do |
| 5: | for dᵢ ∈ D do |
| 6: | Calculate vᵢ = Rₖᵢ + γ(1 − Bᵢ)V(R₍ₖ₊₁₎ᵢ\|Φ_{f-1}) |
| | (* Bᵢ is a binary indicator, indicating if the state Sₖᵢ is the end state of a sequence.) |
| 7: | end for |
| 8: | Φ_{f} = argmin Σ_{di∈D}\|V(Sₖᵢ\|Φ) − vᵢ\|₂ |
| 9: | end for |

[symbol]

indicates data missing or illegible when filed

If any new observations are collected, one can always include them into the dataset D and increase training iterations. However, in this example a finite training set is used, and the converged value function V will be fixed and used for training the policy function. The training process of the policy function involves updating the likelihood of choosing a certain action under the given state according to an advantage value a. As shown in the advantage function in Equation 6, if the sum of the immediate reward R and the discounted value of the subsequent state γV(S₍ₖ₊₁₎ᵢ) is greater than the value of the current state V(Sₖᵢ), then the advantage value αᵢ is positive and the action Aₖᵢ is considered a valuable one, and its likelihood given Sₖᵢ should be increased based on how much the advantage is. However, if the advantage value αᵢ is negative, the updated policy function is less likely to choose Aₖᵢ when encountering Sₖᵢ. When free exploration in a real or simulated environment is not accessible, a negative advantage value may increase the likelihood of the policy selecting an action not represented in the dataset. In other words, the consequence of that action in terms of the resultant state is unknown. To mitigate this issue, e^{α}ᵢ is used to determine how much to increase the likelihood of π(Aₖᵢ |Sₖᵢ). Since e^{α}ᵢ is always positive, a less valuable action observed in the dataset will still have a higher chance of being selected compared to those actions that have never been taken given a certain state.

In addition, the finite training dataset might have an uneven distribution in terms of the actions taken by the human operators. To effectively learn from an imbalanced dataset, researchers have developed methods such as re-sampling, random forest, and cost-sensitive methods. Re-sampling is not a challenge when free exploration is available since the agent can interact with the environment and up-sample those actions which are less common. However, when free exploration is not possible, the cost-sensitive method is an effective methodology to implement in the policy function update scenario. One may define η(Aₖᵢ) to be the likelihood of action Aₖᵢ appearing within the training dataset D. The loss function depends on both the η(Aₖᵢ) and the e^{α}ᵢ. As shown in Equation 7, if an action is frequently taken in the training dataset and has little or negative advantage value, its weight will be low in the loss function. The training process of the policy function is shown in Algorithm 4.

Algorithm 4 Pseudocode of the policy (actor) function training process

| 1: | Initialize learning rate a, discount factor γ | |
|---|---|---|
| 2: | Form the training dataset with samples: dᵢ ∈ D, dᵢ = {Sₖᵢ, Aₖᵢ, S₍ₖ₊₁₎ᵢ, Rₖᵢ}, | |
| | i = 1, 2, ... , N | |
| 3: | Input Φ*, the parameters of the value function from Algorithm 1 | |
| 4: | Randomly initialize Ψ₀, the parameter set of the policy function | |
| 5: | for f = 1: iteration do | |
| 6: | Loss = 0 | |
| 7: | for d ∈ D do | |
| 8: | Calculate the advantage value | |
| | ${a}_{i} = {R}_{ki} + γ ( 1 - {β}_{i} ) V ( {S}_{( k + 1 ) i} \vert {Φ}^{*} ) - V ( {S}_{ki} \vert {Φ}^{*} )$ | (6) |
| | (* βᵢ is a binary indicator, indicating if state S is the end state of a sequence.) | |
| 9: | Update the loss | |
| | $Loss = Loss - \frac{{e}^{{a}_{i}}}{η ( {A}_{ki} )} log ( π ( {A}_{ki} \vert {S}_{ki} , {Ψ}_{f - 1} ) )$ | (7) |

| | |
|---|---|
| 10: | end for |
| 11: | Ψ_{f} = Ψ_{f-1} a∇_{Ψ}Loss |
| 12: | end for |

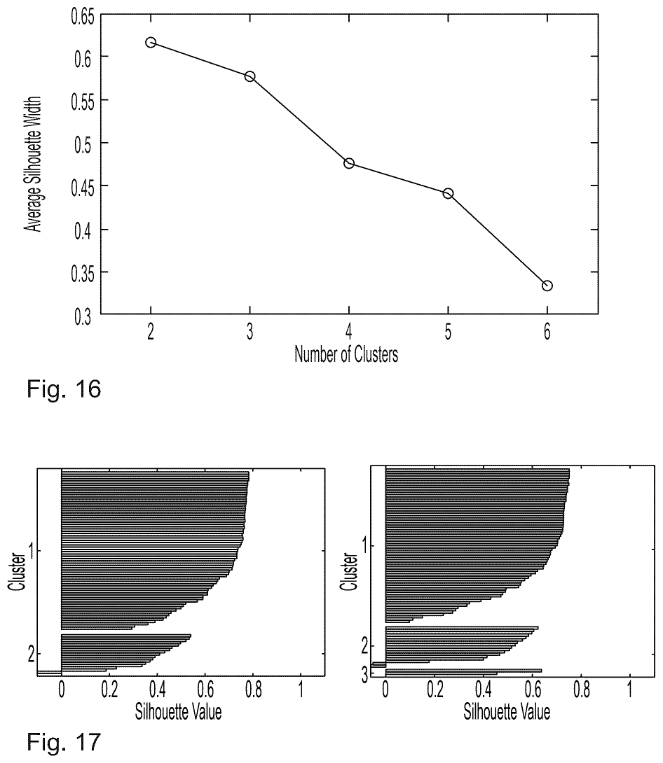

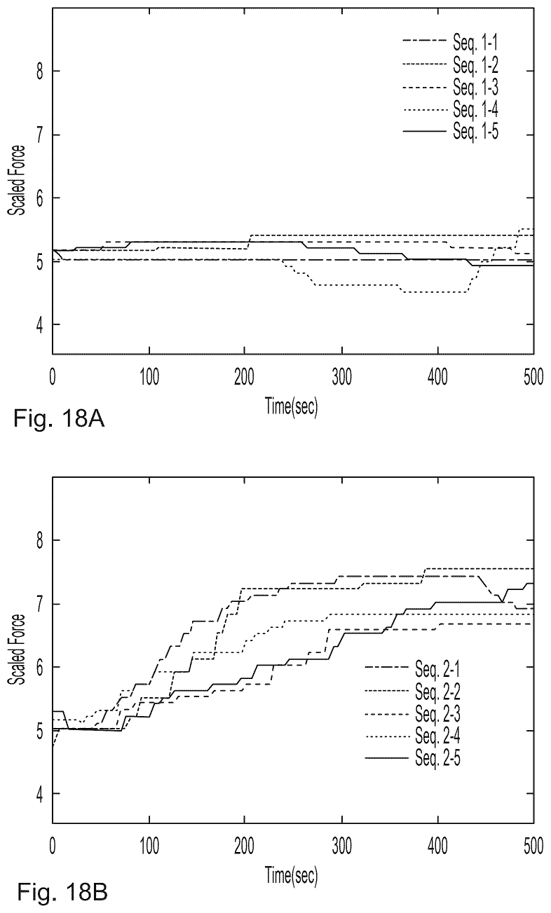

During the start-up process, the casting roll separation force setpoint (to be referred to as the “force setpoint”) is the most frequently adjusted setpoint. Operators adjust the force setpoint to respond to different profile issues as set forth above. The strip chatter (C), a non-negative value indicating the thickness variation along the cast length direction, is a major factor of adjusting the force setpoint. In addition, operators might adjust the force setpoint to respond to another category of profile imperfection, edge spikes. Unlike chatter, which describes profile imperfections along the cast length direction, edge spikes are profile imperfections that lie along the strip cross section. Four parameters are used to characterize different edge spike problems:
(1) Edge bulge (bg): among 0 mm to 25 mm edge region from the outer end, the thickness range from the peak to the closest minima in the direction away from the outer end. It is a non-negative value.
(2) Edge ridge (eg): among 25 mm to 50 mm edge region from the outer end, the thickness range from the peak to the closest minima in the direction away from the outer end. It is a non-negative value.
(3) Maximum peak (mp): maximum thickness between the edge bulge and edge ridge locations with respect to the inner end of the edge region. It is a real value.
(4) High edge flag (fg): a binary value indicating whether either edge region is thicker than the cross section center thickness. FIG. 15 shows a scenario where edge region is thicker than the center region.

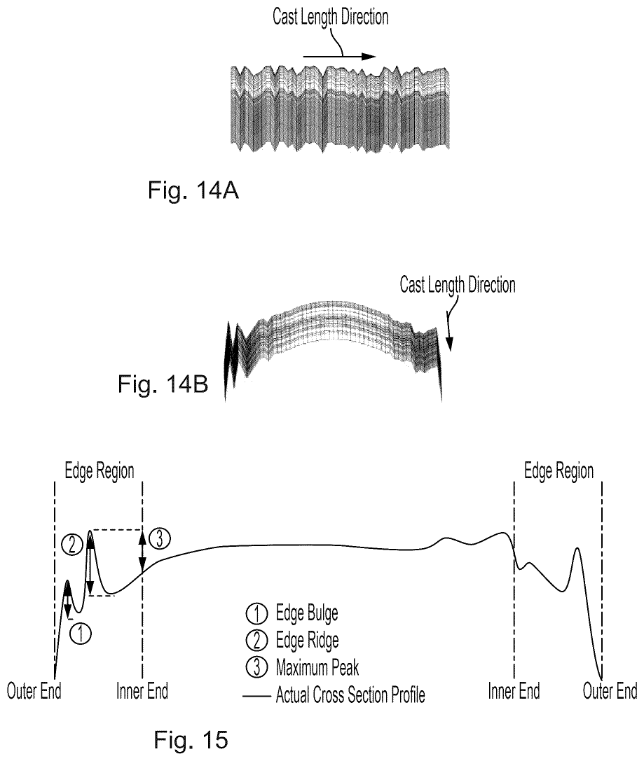

See FIGS. 14 and 15 for illustrations of edge bulge, edge ridge, and maximum peak.

Generally, increasing the force setpoint increases the force applied on the strip surface and reduces the amount of the semi-solid material (also known as “mushy” material) between the solidified shells, which mitigates some edge spike problems. However, the mushy material functions as a damper. which reduces the strip vibration. Therefore, the reduction of the mushy material results in less damping and more vibration in the strip which in turn worsens the chatter problem. Therefore, there is a trade-off between mitigating chatter versus mitigating edge spike problems.

Given that modeling the system dynamics during the start-up process can be difficult, the reinforcement learning agent considered here is designed to learn by only observing the record of human operation and then suggest the optimal setpoint adjustment (value and timing) to the human operator. The state at time step k is composed of

$${S}_{k} = \{ {C}_{k} , Δ {C}_{k} , {F}_{k} , Δ {F}_{k} , {bg}_{k} , Δ {bg}_{k} , {eg}_{k} , Δ {eg}_{k} , {fg}_{k} , Δ {fg}_{k} , m {p}_{k} , Δ m {p}_{k} \} , \qquad ( 8 )$$

where Δ(·)=(·)ₖ−(·)ₖ₋₁ is the difference between values of the current and previous time steps. Cast data is recorded at 1 Hz and smoothed with a 10-second moving-average filter. In addition, based on observation that human operators do not adjust the force setpoint more frequently than 0.2 Hz, the data may be further downsampled to 0.2 Hz to adapt to the force setpoint adjustment frequency used by human operators.

It has also been observed that operators typically adjust the force setpoint by one of eight fixed values, Therefore, at a time step k, the agent is admissible to adjust the force setpoint by one of these eight values Aₖ∈(αⱼ, j=1, 2 . . . , 8). Among these actions, three represent decreasing the force setpoint, four represent increasing the force setpoint, and one is defined as keeping the force setpoint unchanged, A challenging aspect of the specific problem under consideration is that when human operators keep the force setpoint constant, it is not known whether that action was taken deliberately, or if it represents more passive behavior that resulted from an operator being distracted by other operation tasks. How to address this ambiguity is described in more detail below.

The reward function explicitly incentivizes desired performance metrics. Edge spike and chatter are major problems that can be addressed with force setpoint adjustments during a start-up process. The chatter problem is characterized by the chatter parameter value, and the edge spike is characterized by the edge bulge, edge ridge, and maximum peak parameters. The high edge flag parameter is not used to characterize the edge spike problem because it is a binary value and is not comparable to the other three parameters related to edge spike. However, the high edge flag information is embedded in the state vector to provide the agent with extra information to make a decision. It is desirable to have low values of chatter, edge bulge, edge ridge, maximum peak, and a decreasing trend of these parameters. However, once the value of a parameter decreases below a user-defined threshold, continuing to decrease its value is not necessary. Based on these observations, an edge spike parameter is defined as Pₖ=max (bgₖ, egₖ, mpₖ) and construct a piecewise defined reward function for the performance objectives as:

$$( 9 )$$

$${R}_{{S}_{k}} = \{ \begin{matrix}- \frac{Δ {P}_{k}}{2 {W}_{Δ P}} - \frac{Δ {C}_{k}}{2 {W}_{Δ C}} if {P}_{k} < {P}_{l b} and {C}_{k} < {C}_{l b} \\ - \frac{Δ {P}_{k}}{{W}_{Δ P}} + \frac{( {P}_{l b} - {P}_{k} )}{{W}_{P}} - \frac{Δ {C}_{k}}{2 {W}_{Δ C}} if {P}_{k} \geq {P}_{l b} and {C}_{k} < {C}_{l b} \\ - \frac{Δ {P}_{k}}{2 {W}_{Δ P}} - \frac{Δ {C}_{k}}{{W}_{Δ C}} + \frac{( {C}_{l b} - {C}_{k} )}{{W}_{C}} if {P}_{k} < {P}_{l b} and {C}_{k} \geq {C}_{l b} \\ - \frac{Δ {P}_{k}}{{W}_{Δ P}} + \frac{( {P}_{l b} - {P}_{k} )}{{W}_{P}} - \frac{Δ {C}_{k}}{{W}_{Δ C}} + \frac{( {C}_{l b} - {C}_{k} )}{{W}_{C}} if {P}_{k} \geq {P}_{l b} and {C}_{k} \geq {C}_{l b}\end{matrix} ,$$

where W_{Δ(·)} is the weight used to scale Δ(·) in the range [−1, 1], W_{(·)} is the weight used to scale (·) in the range [−2, 2], and C_{lb} and P_{lb} are user-defined thresholds for the chatter and edge spike parameters.

To categorize different force setpoint adjustment behaviors, a k-means clustering algorithm is employed to cluster 95 individual cast sequences in the training dataset. The start-up process of each sequence is operated by one of the six human operators. All of the cast sequences represent the same steel grade and strip width and are collected from the same cast machine to prevent any behavior variation caused by differences in the cast conditions.

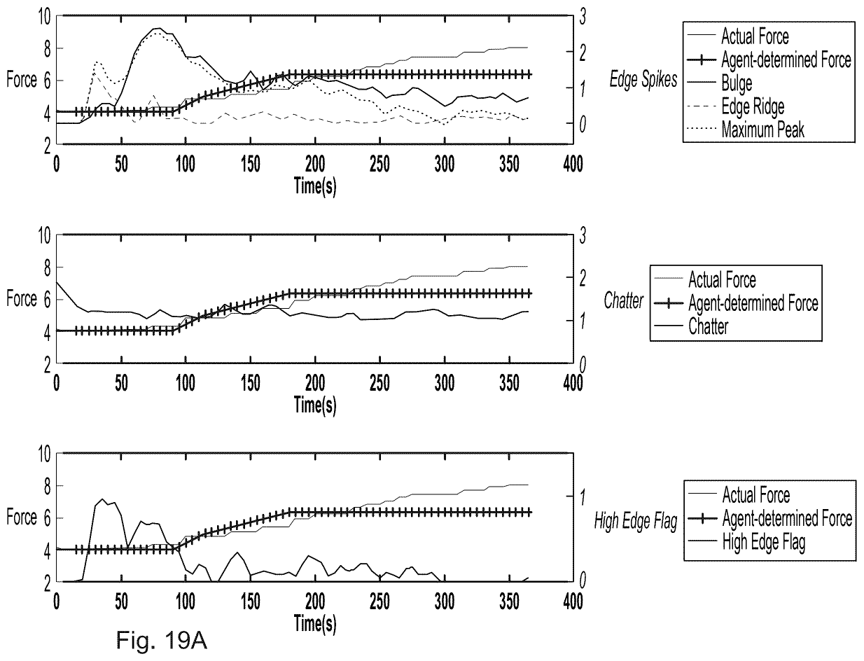

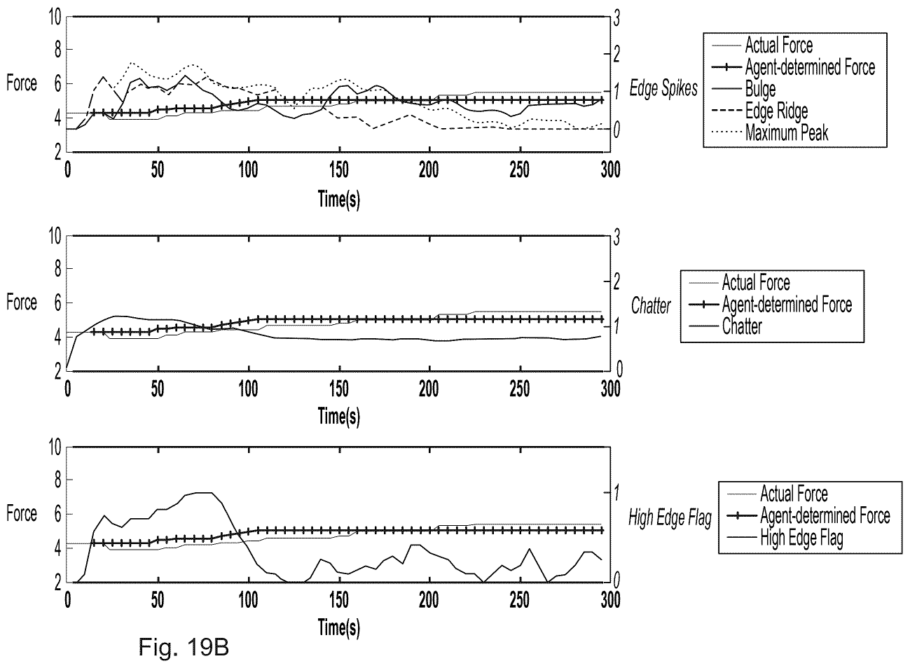

The force setpoint adjustment behavior is characterized by a 500-second force setpoint trajectory after the manual mode of the force setpoint begins. Since there are 6 operators in the data set of this example, the clustering is evaluated as the results of k={2, 3, . . . , 6}. The average silhouette width indicates that both k=2 and k=3 have an average silhouette width higher than 0.5. According to FIG. 17, there is no major difference between k=2 and k=3. Therefore, for simplicity, the clustering results of k=2 are used. FIG. 17a also shows an uneven distribution in the clustering. Combined with the force trajectory examples shown in FIG. 18A (Cluster 1) and FIG. 18B (Cluster 2), over 70% sequences have Cluster 1 force behavior, which is less aggressive in both force adjustment range and frequency. In addition, over 90% of the samples in the training dataset have the zero-force-change action.

Both the value function and the policy function are represented as neural networks. The selection of the neural network architectures is heuristic and shown in Table IV. In one example, the value function has 701 learnable parameters, and the policy function has 848 learnable parameters. The total number of samples used to train these two neural networks is 4594.

TABLE IV
Neural network architectures of the value
function and the policy function

| value function | policy function |
|---|---|
| fully connected layer (12→20) | fully connected layer (12→20) |
| tanh activation layer | leaky ReLU activation layer |
| fully connected layer (20→20) | fully connected layer (20→20) |
| tanh activation layer | leaky ReLU activation layer |
| fully connected output | fully connected output |
| layer (20→1) | layer (20→8) |
| | softmax activation layer |

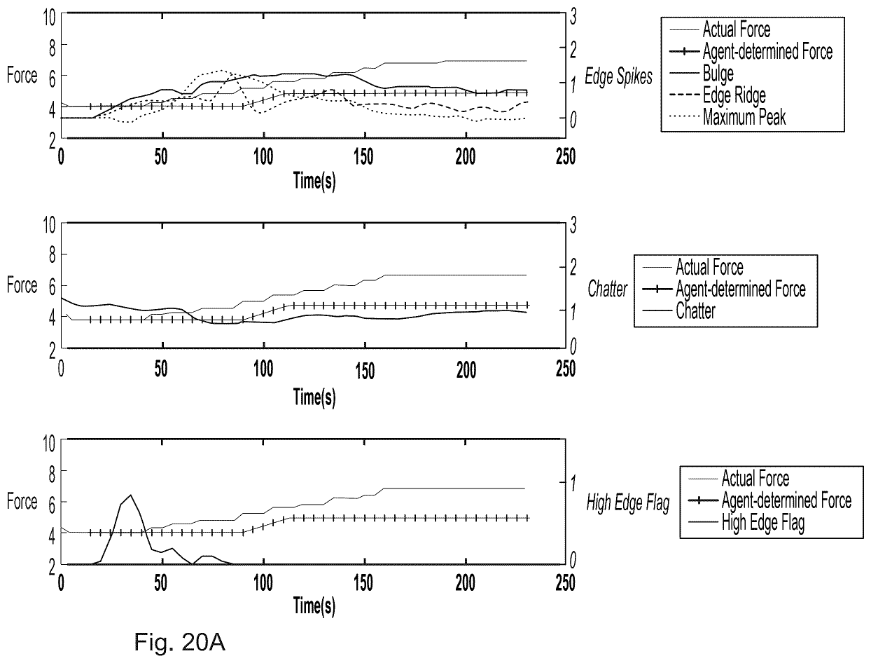

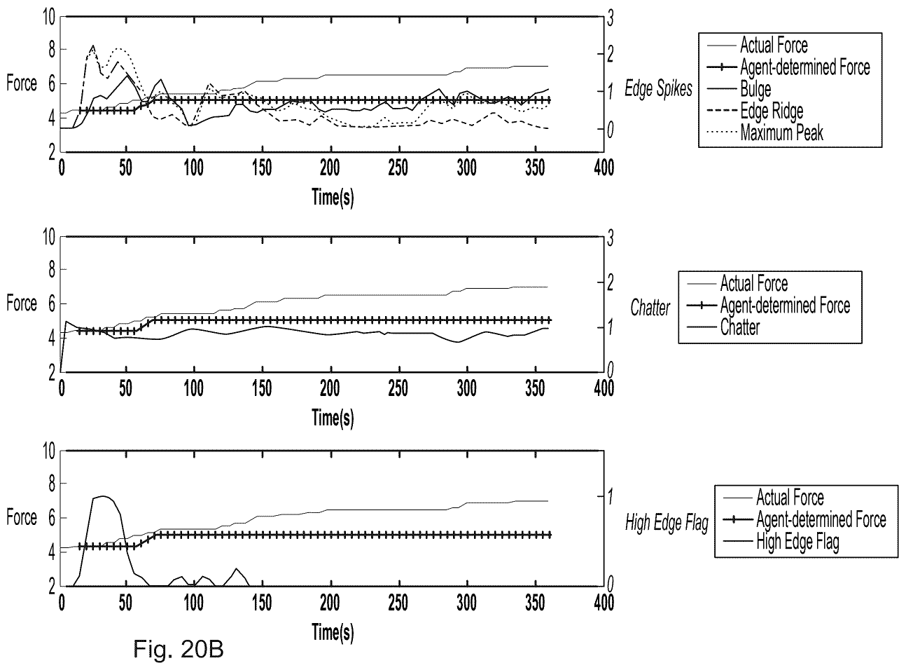

In the testing process, Ninety-five cast sequences are used for training the reinforcement learning agent, and another 8 cast sequences with the same metal grade and width condition are used for testing. Except for the force setpoint values chosen by the human operator F, ΔF, the other defined states are provided to the agent at each time step. At the initial time step, the agent observes the initial force setpoint value and is required to adjust it based on the state information; the decision made by the agent affects the subsequent step's force setpoint value. The goal of this test is to verify whether the trained agent reacts to the twin-roll casting process in a manner that is intuitive given a presence of a particular imperfection in the steel strip. FIGS. 19 and 20 show two pairs (Case 1 and Case 2) of testing sequence comparisons. The action force (blue curve) represents the human operator's actual force trajectory, and the force prediction (black “+” curve) represents the agent's force trajectory.

These comparisons demonstrate two important points. The first point is demonstrated in FIGS. 19A (Case 1) and 19B (Case 2). Case 1 exhibits higher edge spike values compared to Case 2. Because the process is behaving differently between two casts, the RL Agent makes different setpoint decisions; this is desired and expected. In contrast, the underlying human operator trajectories were similar despite the differences in how the process was behaving. The second point is demonstrated in FIGS. 20A (Case 3) and 20B (Case 4). When the objective related parameters are similar between two casts, the agent likewise makes consistent decisions in the two casts. This is in contrast to what the human operator did in the actual casts, which was to make different force setpoint value decisions despite the process behaving similarly. Although these results do not represent closed-loop interaction between the agent and the twin-roll casting process, they provide valuable insight into how the agent would be behave under different casting scenarios.

In one aspect of the present invention, actor-critic algorithm is modified to better accommodate leaming from multiple human experts given the following constraints on the class of settings under consideration:
1) During the algorithm training phase, the only available data are generated by human experts.
2) Multiple experts' data are mixed in a dataset. All experts can stabilize the closed-loop supervisory control system.
3) When experts' performance based on a given criteria is assessed, the performances may not be equally preferred.

Given that the reinforcement learning agent is trained from human data only (and without a process model), the following to hold true:
1) If human experts' behaviors are very consistent, such that the state-action mapping is 1-to-1, the reinforcement learning agent should learn this mapping, exactly.
2) If there exists inconsistency, such that multiple actions are observed being taken under a certain state, the agent should learn to pick the most preferable one.

The exploration nature of the reinforcement learning algorithm is temporarily prohibited by replacing the advantage ai by the natural exponential of exp(αᵢ), because a negative αᵢ results in the action taken by the policy function to depart from the action aᵢ, which is taken by a human expert. The function exp (αᵢ) has the same monotonicity as αᵢ. Therefore, if a sample has a high positive advantage, the corresponding exp (αᵢ) is also high, so the sample is considered as preferable. On the contrary, if a sample has a low positive or negative advantage, its corresponding exp (αᵢ) becomes low, and the sample is considered less preferable.

In addition, a deterministic policy function is desired, but due to the concern of inconsistencies in the training dataset, which is generated by multiple experts, a stochastic policy function π(aᵢ|sᵢ, Ψₕ) is employed to characterize a conditional distribution of action. This policy function plays the role of a sensitivity weight to deal with the imbalanced training dataset. The modified loss function is shown in equation 10.

$${J}_{m} ( {d}_{i} , Ψ ) = \frac{exp ( {α}_{i} )}{π ( {a}_{i} \vert {s}_{i} , {Ψ}_{h} )} ‖ π ( {s}_{i} \vert Ψ ) - {a}_{i} ‖ \qquad ( 10 )$$

Recurrence from the previous step is embedded to improve the actor training process. Samples are reconstructed in the training dataset D, such that every sample dᵢ={aᵢ^{(-1) , s}ᵢ, aᵢ, αᵢ}, where aᵢ ^{(-1 )} is the action taken in the previous step, αⱼ is the advantage. Because this data reconstruction is mainly for the actor training, it is considered that a fixed û has been determined, and the corresponding advantages have been calculated.

The policy function is also redesigned with a dependency of the previous step's action, such that

$${\hat{a}}_{i} = π ( {s}_{i} , {a}_{i}^{( - 1 )} \vert Ψ ) \qquad ( 11 )$$

where âᵢ is the action taken by the policy function π under the given condition. This is enough if only a teacher forcing technique is considered. However, it is also expected of the agent. to perform more robustly, which means that the agent should also be able to tolerate mistakes that it made in previous steps. Therefore, the augmented data is constructed as following. Provided sample dᵢ is not the last step of a trajectory, its corresponding augmented sample is

$${\hat{d}}_{i} = \{ {\hat{a}}_{i} , {s}_{i}^{( + 1 )} , {a}_{i}^{( + 1 )} , {α}_{i}^{( + 1 )} \} \qquad ( 12 )$$

In each iteration, the training process first determines âᵢ based on equation 11 and forms \hat{d}ᵢ based on equation 12. Then, it determines and updates the parameter set Ψ, which satisfies equation 13. The policy function training process with the usage of an augmented dataset is illustrated in Algorithm 5.

$$Ψ = arg min ( {\sum }_{{d}_{i} ∈ D} ( {J}_{m} ( {d}_{i} , Ψ ) + {J}_{m} ( {\hat{d}}_{i} , Ψ ) ) ) \qquad ( 13 )$$

Algorithm 5 Pseudocode of the training process

| | |
|---|---|
| 1: | Form the training dataset with samples dᵢ ∈ D, dᵢ = |
| | $\{ {a}_{i}^{( - 1 )} , {s}_{i} , {a}_{i} , {α}_{i} \} , i = 1 , 2 , … , N$ |
| 2: | for f = 1: iteration do |
| 3: | for dᵢ ∈ D do |
| 4: | ${\hat{a}}_{i} = π ( {s}_{i} , {a}_{i}^{( - 1 )} \vert Ψ ( f ) )$ |
| 5: | if dᵢ is not the end state then |
| 6: | Form \hat{d}ᵢ based on (12) |
| 7: | D ← {D, \hat{d}ᵢ} |
| 8: | end if |
| 9: | end for |
| 10: | Update Ψ (f + 1) based on (13) |
| Il: | end for |

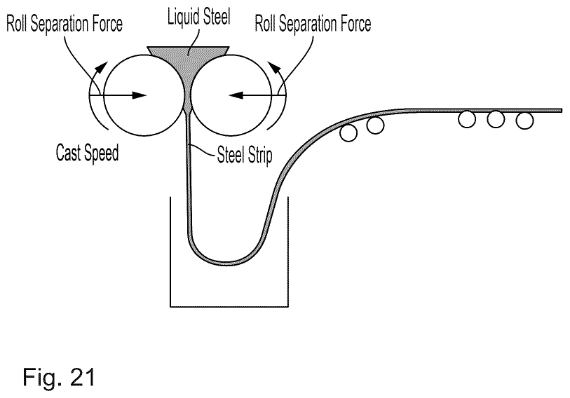

In this embodiment, the focus is on two setpoints: roll separation force and entry gauge thickness. As shown in FIG. 21, the roll separation force setpoint directly affects the force applied to the rollers and therefore to the steel strip. The entry gauge thickness setpoint affects the casting speed; the smaller the setpoint, the faster the rollers. Hereinafter, these setpoints are referred to as the “force” and “thickness” setpoints.

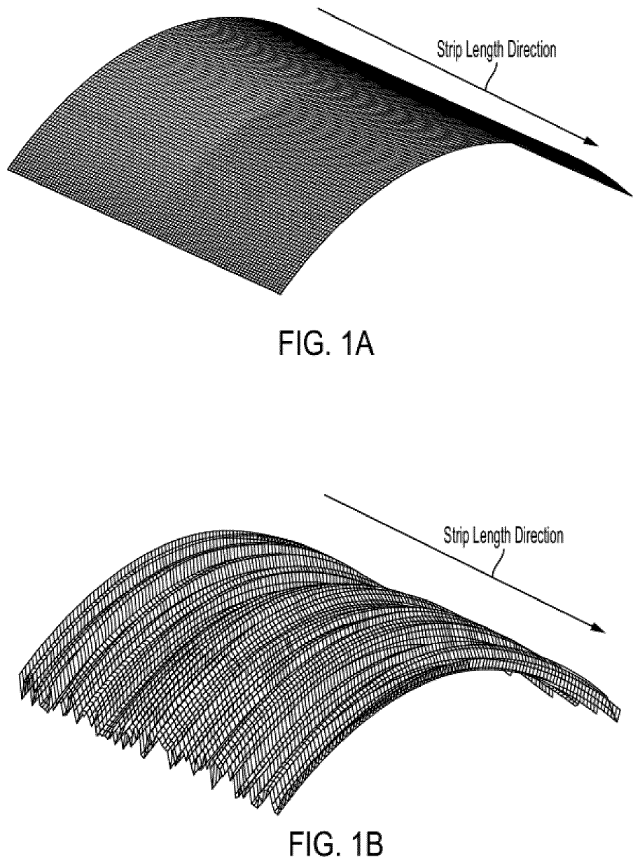

Surface quality and thickness profile uniformity are two of the major concerns in steel strip manufacturing. This includes chatter, a surface imperfection, and edge spikes, a thickness profile non-uniformity. Chatter, as shown in FIG. 1B, is the thickness variation along the cast length direction. Based on the vibration frequency, chatter is separated into high and medium frequency chatter.

Edge spikes characterize thickness imperfections along the cross-section of the strip, as shown in FIG. 15. Four quantities are used to characterize edge spike problems. They are;
1) Edge bulge (bg): among 0 to 25 mm edge region from the outer end, the thickness ranges from the peak to the closest minima in the direction away from the outer end. It is a non-negative value.
2) Edge ridge (eg): among 25 mm to 50 mm edge region from the outer end, the thickness ranges from the peak to the closest minima in the direction away from the outer end. It is a non-negative value.
3) Maximum peak (mp): maximum thickness between the edge bulge and edge ridge locations with respect to the inner end of the edge region. It is a real value.
4) High edge flag (fg): a binary value indicating whether either edge region is thicker than the cross-section center thickness.

In some embodiments the state, action, and reward function are constructed as follows.

State: With a fixed number of state elements, we prefer to encode more information about the dynamics. Therefore, the state vector is defined as

$${s}_{i} = \{ {Ch}_{i} , {Δ ( Ch )}_{i} , {Cm}_{i} , {Δ ( Cm )}_{i} , {bg}_{i} , \\ {Δ ( bg )}_{i} , {fg}_{i} , {Δ ( fg )}_{i} , {rg}_{i} , {Δ ( rg )}_{i} , m {p}_{i} , {Δ ( m p )}_{i} , {\overline{Th}}_{i} , {t}_{i} \} , \qquad ( 14 )$$

where Chᵢ and Cmᵢ are the high and medium frequency chatters of the sample dᵢ, T̅hᵢ is the allowed minimum thickness value, tᵢ is the time with respect to the time that a human operator can begin adjusting setpoints, and for any element x, Δ(x)ᵢ=xᵢ−xi⁽⁻¹⁾ is the difference between two consecutive steps. The time and the allowed minimum thickness are also included in the state vector, because a desired strip thickness is a part of the final product requirement. Any decision causing the thickness setpoint to be less than the allowed minimum thickness should result in a penalty. As the time increases, the penalty also increases.

Action: The action is simply defined as the force (F) and thickness (Th) setpoint values at the next time step:

$${a}_{i} = \{ {F}_{i}^{( + 1 )} , {Th}_{i}^{( + 1 )} \} , \qquad ( 15 )$$

Reward: The reward function is a function of all control objectives in the state vector, including every element except t and T̅h̅, which are considered separately below. Furthermore, the reward is a varying weighted sum of all control objectives, such that

$${r}_{i} = R ( {s}_{i} ) = - {W ( {s}_{i} )}^{T} {s}_{i} , \qquad ( 16 )$$

where W(sᵢ) is the piece-wise linear weighting function for the state vector. When a control objective xi in the state vector is lower than its threshold, the weights corresponding to both the objective xᵢ and its change Δ(x)ᵢ decrease. The weighting function is always non-negative, and so the negative sign in front of it makes lower values and decreasing trends of control objectives result in higher rewards.

The time-dependent thickness penalty is directly encoded in a loss function as

$${J}_{Th} ( {d}_{i} , Ψ ) = t ( max ( 0 , {\overline{Th}}_{i} - {\hat{Th}}_{i}^{( + 1 )} ( Ψ ) ) ) . \qquad ( 17 )$$

$$Note that$$

$$\{ {\hat{F}}_{i}^{( + 1 )} ( Ψ ) , {\hat{Th}}_{i}^{( + 1 )} ( Ψ ) \} = {\hat{a}}_{i} ( Ψ ) = π ( {s}_{i} , {a}_{i}^{( - 1 )} \vert Ψ ) , \qquad ( 18 )$$

where \hat{T}hᵢ(+1) (Ψ) is the thickness setpoint adjustment decided by the policy function π. The thickness penalty loss J_{TH} is then used to determine the parameter set Ψ simply by replacing Jₘ in equation 13 by J defined in equation 19.

$$J ( {d}_{i} , Ψ ) = {J}_{m} ( {d}_{i} , Ψ ) + {J}_{Th} ( {d}_{i} , Ψ ) \qquad ( 19 )$$

As discussed above, the training process relies only on data generated by human experts, because there is not yet an available simulator due to the system complexity. However, we still want to assess and compare the trained agents prior to actual implementation. Accordingly, a method to evaluate an agent performance without a simulator is provided. Then an agent trained with the recurrent augmented dataset may be compared to an agent without the augmented dataset.

Similar to the sequence-to-sequence RNN, the policy function is asked to generate a setpoint trajectory {â⁽⁺¹⁾, â⁽⁺²⁾, . . . , â^{(+K)}} based on a K-step state trajectory {s⁽⁺¹⁾, s⁽⁺²⁾, . . . , s^{(+K)}}. Since the policy function has its recurrence from the previous output, as shown in equation 11, the action taken by the agent at time step k should be

$${\hat{a}}^{( k )} = π ( {s}^{( + k )} , {\hat{a}}^{( + k - 1 )} \vert Ψ ) , \qquad ( 20 )$$

and when k=1, the initial action a⁽⁰⁾ is given.

Suppose the K-step state trajectory results from a setpoint trajectory {a⁽⁺¹⁾, a⁽⁺²⁾, . . . , a^{(+K)}} generated by a human expert. As mentioned earlier, if all human experts share the same consistent control policy, then the agent is supposed to perfectly learn the policy, and the setpoint trajectories generated by the human expert or the agent should also be similar. However, if there exists policy inconsistency, which may cause an imperfect imitation of the expert's control policy, then the agent should prioritize learning from samples with higher advantages. Therefore, for each time step k, the advantage α(k) can be calculated based on equation 22, in which β^{(k)} is a binary indicator to show whether the step k is the end step of a sequence. A validation loss is defined as

$${J}_{v} ( k ) = exp ( {α}^{( + k )} ) ‖ {a}^{( + k )} - {\hat{a}}^{( + k )} ‖ . \qquad ( 21 )$$

$$α ( k ) = R ( {s}^{( k )} ) + ( 1 - {β}^{( k )} ) γ \hat{V} ( {s}^{( k + 1 )} ) - \hat{V} ( {s}^{( k )} ) \qquad ( 22 )$$

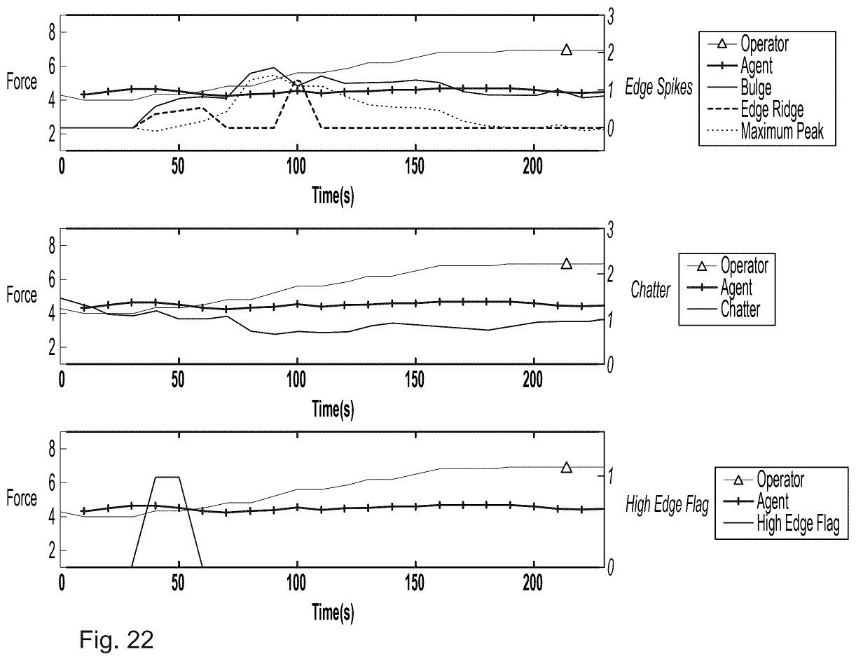

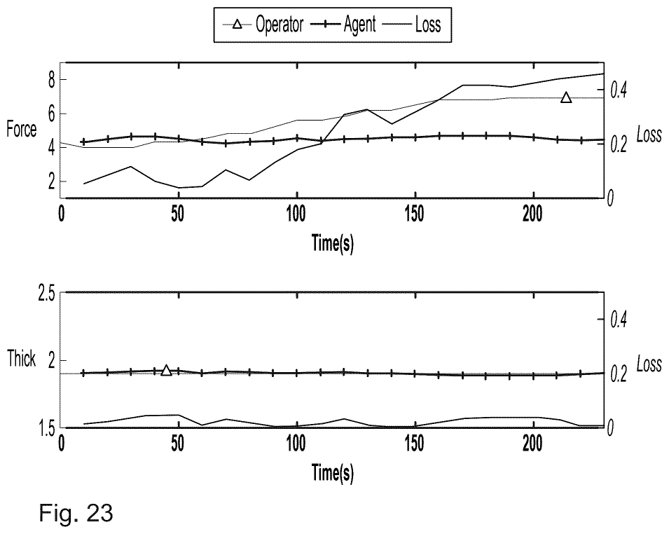

Two agents using eight unseen testing sequences are compared herein. Trajectory plots of one sequence are shown in detail, and the loss statistics of all eight sequences are shown and discussed. FIG. 22 shows the force trajectory of the agent without the augmented dataset. The presented cast sequence has increasing edge spikes from the start of the casting sequence. Correspondingly, the human expert increases the force setpoint. After about 100 second, the edge spike values start to decrease. The agent-determined force trajectory starts to deviate from the actual force trajectory chosen by the human expert at about 50 second, and the difference between the two trajectories increases as time increases. Correspondingly, in FIG. 23, the loss of the force tracking increases over the sequence. The agent determined thickness follows the human-selected thickness well, so the loss of the thickness tracking remains low.

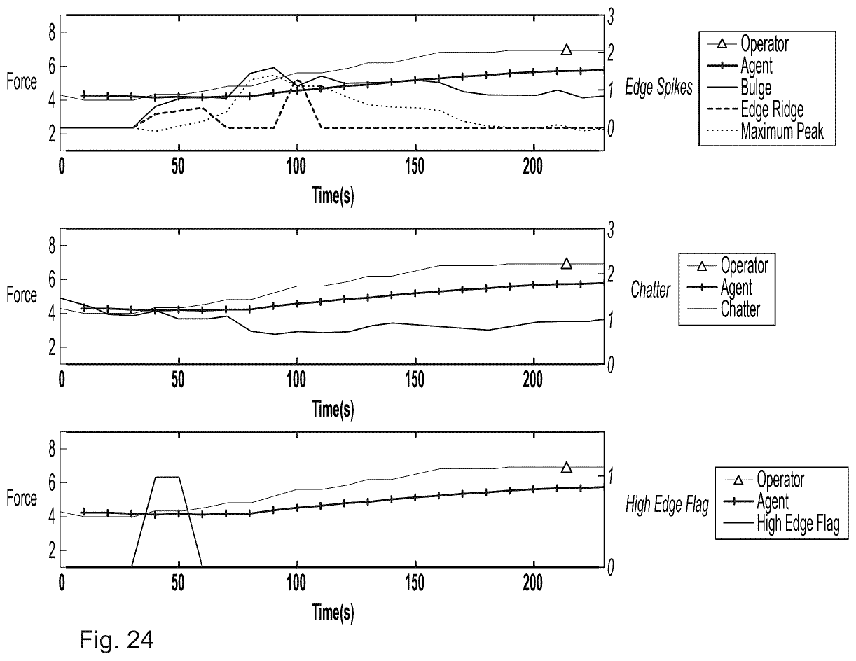

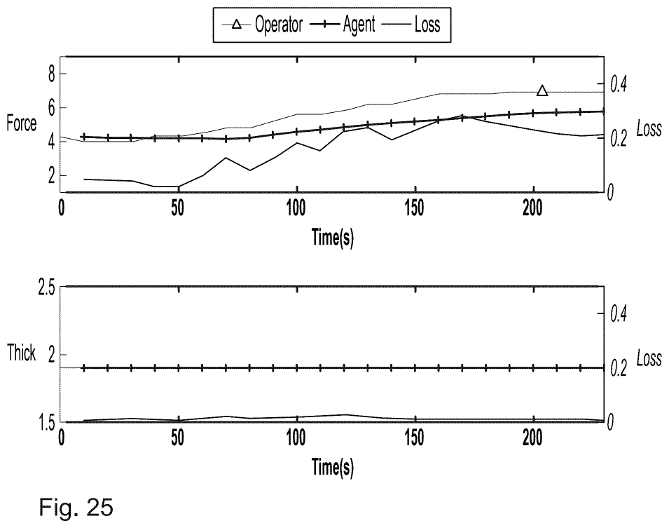

FIG. 24 shows the force trajectory of the agent with the augmented dataset. Although the agent with augmented dataset also keeps the force setpoint unchanged at the beginning of the cast, at about 75 second, as edge spikes go over 1 and continue increasing, the agent starts to increase the force setpoint. When the loss corresponding to this agent in FIG. 25 is seen, the loss of the force tracking still increases as time increases, although the difference between the agent determined force and the actual force does not increase. That is because the loss is a weighted difference between the agent-determined force setpoint and the true force, according to equation 21. In this sequence, the advantage α^{(+k)} increases as k increases. Therefore, although the tracking error remains unchanged, the loss increases. Table IV shows the loss statistics of all testing sequences. By training with augmented data, both losses corresponding to the force and the thickness tracking are improved in most testing sequences.

TABLE IV
LOSS STATISTICS OF TESTING SEQUENCES

| | Without Augmented Data | | | With Augmented Data | | |
|---|---|---|---|---|---|---|
| | | | Total | | | Total |
| | Force | Thickness | Loss | Force | Thickness | Loss |
| Seq. 1 | 0.247 | 0.023 | 0.270 | 0.161 | 0.012 | 0.173 |
| Seq. 2 | 0.164 | 0.040 | 0.204 | 0.129 | 0.010 | 0.139 |
| Seq. 3 | 0.034 | 0.010 | 0.044 | 0.054 | 0.008 | 0.062 |
| Seq. 4 | 0.088 | 0.034 | 0.122 | 0.064 | 0.011 | 0.075 |
| Seq. 5 | 0.132 | 0.054 | 0.186 | 0.141 | 0.022 | 0.163 |
| Seq. 6 | 0.051 | 0.084 | 0.135 | 0.054 | 0.008 | 0.062 |
| Seq. 7 | 0.112 | 0.077 | 0.189 | 0.090 | 0.018 | 0.108 |
| Seq. 8 | 0.062 | 0.033 | 0.095 | 0.039 | 0.024 | 0.063 |

In this embodiment, recurrent features are embedded to improve the performance of a reinforcement learning controller for a complex supervisory control scenario. As in other embodiments, the problem setting considers no available system model, and reinforcement learning algorithm is supposed to evaluate, select, and learn from data of multiple human experts. Augmented datasets are constructed iteratively to perturb the output recurrence to enhance the robustness of the action learning process in later steps in sequences. In the context of a supervisory control problem with a twin-roll casting example, an agent trained with recurrent augmented datasets performs better in advantageous action tracking over testing sequences compared to an agent trained without using any recurrent augmented dataset.

Additional actions may also be assigned to the RL Agent. For example, the RL Agent may be trained to reduce periodic disturbances by controlling wedge control for the casting rollers. Some embodiments include localized temperature control of the casting rollers to control casting roller shape and thereby cast strip profile. See, for example, WO 2019/217700, which is incorporated by reference. In some embodiments, the strip profile measurements are used in a reward function so the RL Agent can control the localized heating and/or cooling of the casting rolls to control strip profile.

Actions may also be extended to other portions of the twin roll caster process equipment, including control of the hot rolling mill 16 and water jets 18. For example, various controls have been developed for shaping the work rolls of the hot rolling mill to reduce flatness defects. For example, work roll bending jacks have been provided to affect symmetrical changes in the roll gap profile central region of the work rolls relative to regions adjacent the edges. The roll bending is capable of correcting symmetrical shape defects that are common to the central region and both edges of the strip. Also, force cylinders can affect asymmetrical changes in the roll gap profile on one side relative to the other side. The roll force cylinders are capable of skewing or tilting the roll gap profile to correct for shape defects in the strip that occur asymmetrically at either side of the strip, with one side being tighter and the other side being looser than average tension stress across the strip. In some embodiments, a RL. Agent is trained to provide actions to each of these controls in response to measurements of the cast strip before and/or after hot rolling the strip to reduce thickness.

Another method of controlling a shape of a work roll (and thus the elongation of cast strip passing between the work rolls) is by localized, segmented cooling of the work rolls. See. for example, U.S. Pat. No. 7,181,822, which is incorporated by reference, By controlling the localized cooling of the work surface of the work roll, both the upper and lower work roll profiles can be controlled by thermal expansion or contraction of the work rolls to reduce shape defects and localized buckling. Specifically, the control of localized cooling can be accomplished by increasing the relative volume or velocity of coolant sprayed through nozzles onto the work roll surfaces in the zone or zones of an observed strip shape buckle area, causing the work roll diameter of either or both of the work rolls in that area to contract, increasing the roll gap profile, and. effectively reducing elongation in that zone. Conversely, by decreasing the relative volume or velocity of the coolant sprayed by the nozzles onto the work surfaces of the work rolls causes the work roll diameter in that area to expand, decreasing the roll gap profile, and effectively increasing elongation. Alternatively or in combination, the control of localized cooling can be accomplished by internally controlling cooling the work surface of the work roll in zones across the work roll by localized control of temperature or volume water circulated through the work rolls adjacent the work surfaces. In some embodiments, a RL Agent is trained to provide actions to provide localized, segmented cooling of the work rolls in response to casting mill metrics, such as flatness defects.

In some embodiments, the RL Agent in any of the above embodiments receives reinforcement learning not only from casting campaigns controlled manually by operators, but also from the RL Agent's own operation of a physical casting machine. That is, in operation, the RL Agent continues to learn through reinforcement learning including real-time casting machine metrics in response to the RL Agent's control actions, thereby improving the RL Agent's and the casting machine's performance.

In some embodiments, intelligent alarms are included to alert operators to intervene if necessary. For example, the RL Agent may direct a step change but receive an unexpected response. This may occur, for example, if a sensor fails or an actuator fails.

The functional features that enable an RL agent to effectively drive all process set points and also enable process and machine condition monitoring constitutes an autonomously driven twin roll casting machine where an operator is required to intervene only in the instances where there is a machine component breakdown or a process emergency (such as failure of a key refractory element).

It is appreciated that any method described herein utilizing any reinforced learning agent as described or contemplated, along with any associated algorithm, may be performed using one or more controllers with the reinforced learning agent is stored as instructions on any memory storage device. The instructions are configured to be performed (executed) using one or more processors in combination with a twin roll casting machine to control the formation of thin metal strip by twin roll casting. Any such controller, as well as any processor and memory storage device, may be arranged in operable communication with any component of the twin roll casting machine as may be desired, which includes being arranged in operable communication with any sensor and actuator. A sensor as used herein may generate a signal that may be stored in a memory storage device and used by the processor to control certain operations of the twin roll casting machine as described herein. An actuator as used herein may receive a signal from the controller, processor, or memory storage device to adjust or alter any portion of the twin roll casting machine as described herein.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Furthermore, it is understood that the features of any specific embodiment discussed herein may be combined with one or more features of any one or more embodiments otherwise discussed or contemplated herein unless otherwise stated.

What is claimed is:

1. A twin roll casting system, comprising:
a pair of counter-rotating casting rolls having a nip between the casting rolls and capable of delivering cast strip downwardly from the nip;
a casting roll controller configured to adjust at least one process control setpoint between the casting rolls in response to control signals;
a cast strip sensor capable of measuring at least one parameter of the cast strip; and
a controller coupled to the cast strip sensor to receive cast strip measurement signals from the cast strip sensor and coupled to the casting roll controller to provide control signals to the casting roll controller, the controller comprising a reinforcement learning (RL) Agent;
the RL Agent further comprising a model-free actor-critic agent having a value function and a policy function, the RL Agent having been trained on a plurality of casting system operation datasets composed of casting runs executed by a plurality of different human operators.

2. The twin roll casting system of claim 1 wherein the RL Agent further comprises an advantage function which calculates an advantage value for a selected action as an immediate reward value for a selected action plus a discounted value of a subsequent state for the selected action minus a value of current state; and wherein the advantage value is used to train the policy function.

3. The twin roll casting system of claim 2 wherein the policy function is configured evaluate the advantage function in a way that values an action from the plurality of casting system operation datasets having a negative advantage value over actions that are not found in the plurality of casting system operation datasets.

4. The twin roll casting system of claim 1 wherein the RL Agent further comprises an advantage function which calculates an advantage value for a selected action as an immediate reward value for a selected action plus a discounted value of a subsequent state for the selected action minus a value of current state; and
wherein the natural exponent of the advantage value is used to train the policy function.

5. The twin roll casting system of claim 1, wherein the cast strip sensor comprises a thickness gauge that measures a thickness of the cast strip in intervals across a width of the cast strip.

6. The twin roll casting system of claim 1, wherein the process control setpoint comprises a force setpoint between the casting rolls; and
wherein the parameter of the cast strip comprises chatter.

7. The twin roll casting system of claim 1, wherein the RL Agent further comprises a reward function calculating an immediate reward as a piecewise defined reward function:
$${R}_{{S}_{k}} = \{ \begin{matrix}- \frac{Δ {P}_{k}}{2 {W}_{Δ P}} - \frac{Δ {C}_{k}}{2 {W}_{Δ C}} if {P}_{k} < {P}_{l b} and {C}_{k} < {C}_{l b} \\ - \frac{Δ {P}_{k}}{{W}_{Δ P}} + \frac{( {P}_{l b} - {P}_{k} )}{{W}_{P}} - \frac{Δ {C}_{k}}{2 {W}_{Δ C}} if {P}_{k} \geq {P}_{l b} and {C}_{k} < {C}_{l b} \\ - \frac{Δ {P}_{k}}{2 {W}_{Δ P}} - \frac{Δ {C}_{k}}{{W}_{Δ C}} + \frac{( {C}_{l b} - {C}_{k} )}{{W}_{C}} if {P}_{k} < {P}_{l b} and {C}_{k} \geq {C}_{l b} \\ - \frac{Δ {P}_{k}}{{W}_{Δ P}} + \frac{( {P}_{l b} - {P}_{k} )}{{W}_{P}} - \frac{Δ {C}_{k}}{{W}_{Δ C}} + \frac{( {C}_{l b} - {C}_{k} )}{{W}_{C}} if {P}_{k} \geq {P}_{l b} and {C}_{k} \geq {C}_{l b}\end{matrix} ,$$
where W Δ(·) is the weight used to scale Δ(·) in the range [−1, 1], W(·) is the weight used to scale (·) in the range [−2, 2], and C_{lb} and P_{lb} are user-defined thresholds for the chatter and edge spike parameters.

8. The twin roll casting system of claim 1 further comprising an advantage function which calculates an advantage value as an immediate reward value for a selected action plus a discounted value of a subsequent state for the selected action minus a value of current state;
wherein the immediate reward is calculated by a reward function calculating an immediate reward as a weighted piecewise defined reward function based on user-defined thresholds for the chatter and edge spike parameters.

9. The twin roll casting system of claim 1, wherein the at least one parameter of the cast strip comprises chatter and at least one strip profile parameter.

10. The twin roll casting system of claim 9, wherein the at least one strip profile parameter is selected from the group consisting of edge bulge, edge ridge, maximum peak, and high edge flag.

11. The twin roll casting system of claim 1, wherein the policy function comprises a stochastic policy function.

12. The twin roll casting system of claim 1, wherein the policy function includes a dependency on a previous step's action.

13. The twin roll casting system of claim 1, wherein for each step in an operation dataset, recurrence from the previous step is embedded to improve the actor training process.
